(19) United States
(12) Patent Application Publication
(10) Pub. No.: US 2012/0140278 A1
(43) Pub. Date: Jun. 7, 2012

(54) DOCUMENT INFORMATION DISPLAY CONTROL DEVICE, DOCUMENT INFORMATION DISPLAY METHOD, AND COMPUTER-READABLE STORAGE MEDIUM FOR COMPUTER PROGRAM

(75) Inventors: Hisashi Sousa, Kobe-shi (JP); Masanori Nishida, Kobe-shi (JP)

(73) Assignee: KONICA MINOLTA BUSINESS TECHNOLOGIES, INC., Tokyo (JP)

(21) Appl. No.: 13/311,185

(22) Filed: Dec. 5, 2011

(30) Foreign Application Priority Data
Dec. 7, 2010 (JP) 2010-272930
Dec. 8, 2010 (JP) 2010-273412

(51) Int. Cl. G06K 15/02

(52) U.S. Cl. 358/1.15

(57) ABSTRACT

A document information display control device is provided which displays, on a display, information on a document having a plurality of pages. The device includes a detector configured to detect an entire state and an individual state that are probably found in a first case where a printer obtains a printed matter of the document by printing the document, or, in a second case where a finisher applies finishing processing to the printed matter, the entire state being a state on an entirety of the printed matter, the individual state being a state on each of the plurality of the pages; and a state information display control portion configured to display a screen including entire state information and individual state information, the entire state information indicating the entire state detected by the detector, and the individual state information indicating the individual state detected by the detector.

This application is based on Japanese patent application No. 2010-272930 and No. 2010-273412 filed on Dec. 7, 2010, and Dec. 8, 2010, respectively, the contents of which are hereby incorporated by reference.

### BACKGROUND OF THE INVENTION

1. Field of the Invention

The present invention relates to a device and a method for previewing a document before producing a printed matter thereof, and so on.

2. Description of the Related Art

Techniques have recently become available to display an image showing the appearance of the finished document before actually producing a printed matter of the document. Such a display is generally called a “preview”.

Users can check whether or not a document has defect(s) by producing a preview of the document before printing out images on the document onto paper. This leads to the reduction in paper consumption.

The following technology has been proposed as a technology related to a preview. At the time when a print preview is displayed by a print preview display part, a printing conditions acquisition part acquires printing conditions of printing data, and an executing printing device information acquisition part acquires the device information from the printing device specified by the user. A printing possibility determination part determines whether it is possible or not to conduct printing based on the printing data by the printing device specified based on the printing conditions and the device information. As the result of the printing possibility determination, a printing possibility determination result display part displays the information to the effect that printing is possible if printing can be conducted, and the information to the effect that printing is not possible together with its reason if printing can not be conducted, on the print preview screen of the display part (English abstract of Japanese Laid-open Patent Publication No. 2006-155465).

Further, the following technology has also been proposed. A setting under which an operator tends to make an error in printing (hereinafter referred to as “erroneous setting”) is registered in advance. For printing, the print setting made at the time and the erroneous setting are compared with each other. When the print setting corresponds to the erroneous setting, the operator is informed of the fact (Japanese Laid-open Patent Publication No. 2007-058428).

However, in the conventional technologies related to a preview, if a document has a plurality of pages, a user has to check whether or not there are defects in the document on a page-by-page basis. The more pages the document has, the more laborious work the user has to do.

### SUMMARY

The present disclosure is directed to solve the problems pointed out above, and therefore, an object of an embodiment of the present invention is to facilitate operation, by a user, for checking a document having a plurality of pages, compared to the conventional technologies.

A document information display control device according to an aspect of the present invention is a document information display control device for displaying, on a display, information on a document having a plurality of pages. The device includes a detector configured to detect an entire state and an individual state that are probably found in a first case where a printer obtains a printed matter of the document by printing the document, or, in a second case where a finisher applies finishing processing to the printed matter, the entire state being a state on an entirety of the printed matter, the individual state being a state on each of the plurality of the pages; and a state information display control portion configured to display a screen including entire state information and individual state information, the entire state information indicating the entire state detected by the detector, and the individual state information indicating the individual state detected by the detector.

These and other characteristics and objects of the present invention will become more apparent by the following descriptions of preferred embodiments with reference to drawings.

### BRIEF DESCRIPTION OF THE DRAWINGS

FIG. 1 is a diagram showing an example of the overall configuration of a network system.

FIG. 2 is a diagram showing an example of the hardware configuration of an image forming apparatus.

FIG. 3 is a diagram showing an example of the hardware configuration of a personal computer.

FIG. 4 is a diagram showing an example of the functional configuration of a personal computer.

FIG. 5 is a diagram showing an example of a print preview window.

FIG. 6 is a diagram showing an example of a structure of warning data.

FIG. 7 is a diagram showing an example of data contained in a header part.

FIG. 8 is a diagram showing an example of data contained in a page warning data part.

FIG. 9 is a diagram showing an example of a warning message region.

FIG. 10 is a diagram showing an example of a warning dialog box.

FIGS. 11A and 11B are diagrams showing an example of change in warning message region.

FIGS. 12A and 12B are diagrams depicting an example of cursor movement.

FIGS. 13A and 13B are diagrams depicting an example of cursor movement.

FIG. 14 is a flowchart depicting an example of the flow of processing performed when a print preview window is displayed.

FIG. 15 is a flowchart depicting an example of the flow of warning display processing.

FIG. 16 is a flowchart depicting an example of the flow of processing performed after a print preview window is displayed.

FIG. 17 is a flowchart depicting an example of the flow of list processing.

FIG. 18 is a diagram showing a modified example of the functional configuration of a personal computer.

FIG. 19 is a diagram showing an example of a print preview window.

FIG. 20 is a diagram showing an example of a preview image for 2-in-1 printing.

FIG. 21 is a diagram showing an example of a print preview window.

FIG. 22 is a flowchart depicting an example of the flow of processing performed when a print preview window is displayed.

FIG. 23 is a diagram showing an example of a print preview window in which a warning message region is provided.

FIG. 24 is a diagram showing an example of a print preview window.

FIG. 25 is a diagram showing an example of a print preview window.

FIG. 26 is a diagram showing an example of a print preview window.

FIG. 27 is a diagram showing an example of a print preview window.

FIG. 28 is a diagram showing an example of a print preview window displayed on a touch-sensitive panel display.

FIG. 29 is a diagram showing an example of a driver screen having a region corresponding to a print preview window.

### DESCRIPTION OF THE PREFERRED EMBODIMENTS

### First Embodiment

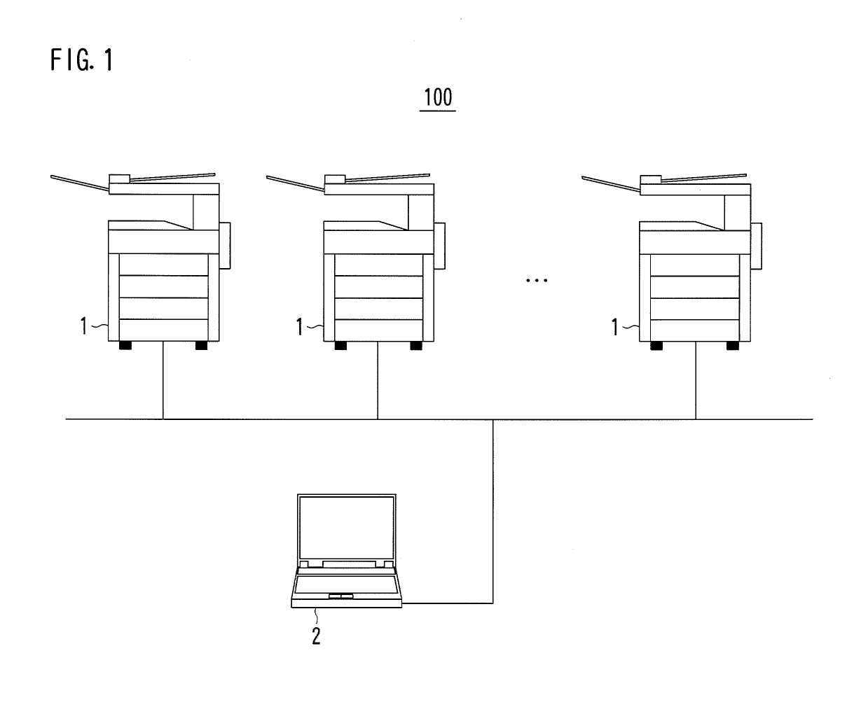

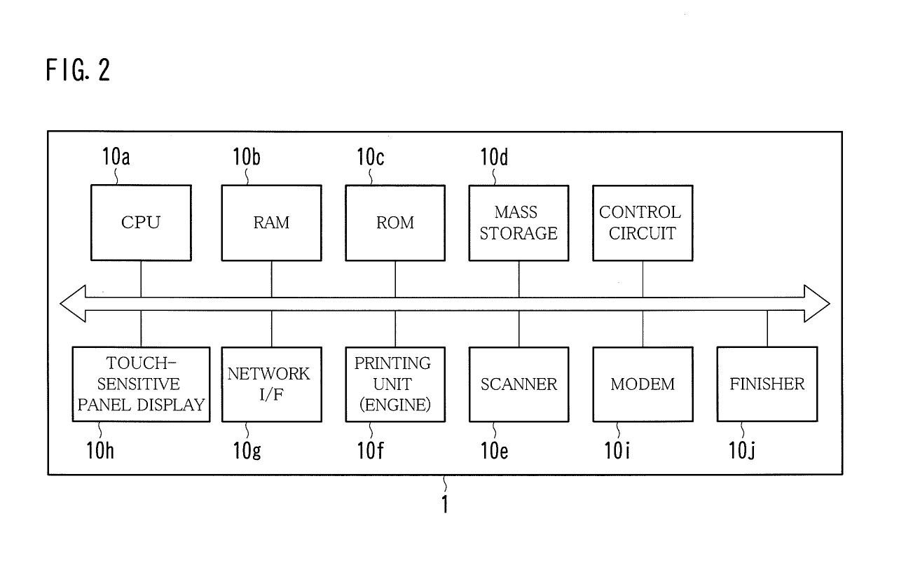

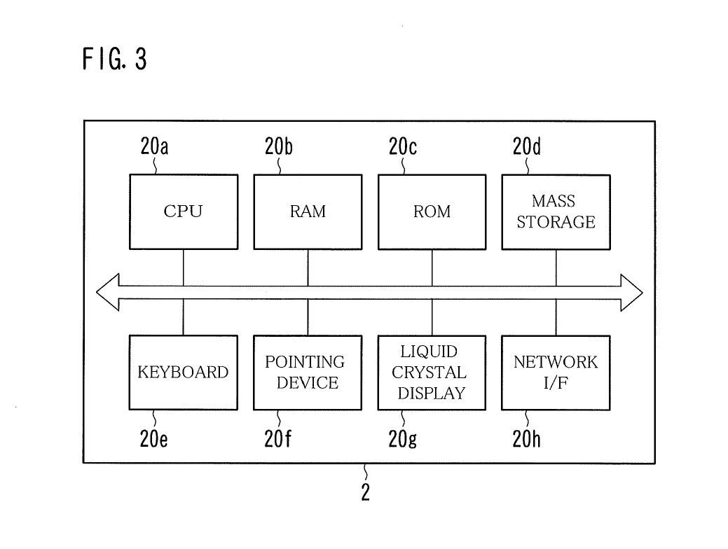

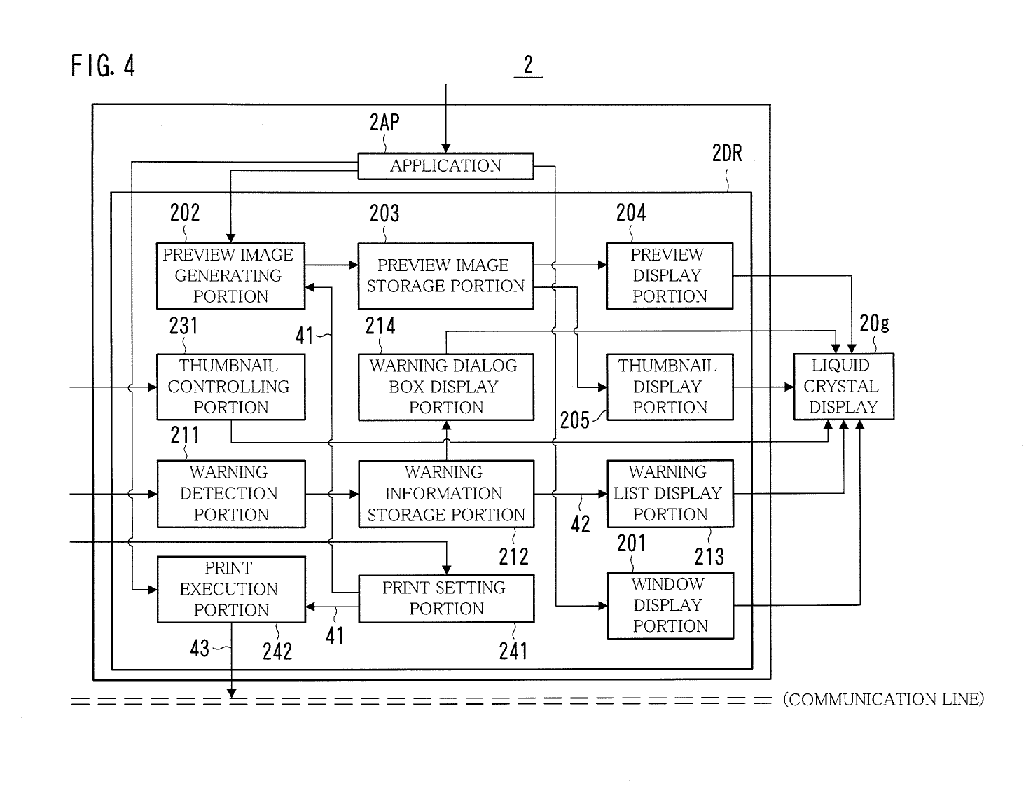

FIG. 1 is a diagram showing an example of the overall configuration of a network system 100; FIG. 2 is a diagram showing an example of the hardware configuration of an image forming apparatus 1; FIG. 3 is a diagram showing an example of the hardware configuration of a personal computer 2; and FIG. 4 is a diagram showing an example of the functional configuration of the personal computer 2.

Referring to FIG. 1, the network system 100 is configured of one or more image forming apparatuses 1, one or more personal computers 2, and the like.

The image forming apparatus 1 is generally called a “multifunction device”, a “Multi-Functional Peripheral (MFP)”, or the like. The image forming apparatus 1 is an apparatus that integrates a variety of functions, such as copying, network printing (PC printing), faxing, and scanning, into a single unit.

The image forming apparatus 1 is capable of sending and receiving image data with a device such as the personal computer 2 via a communication line, e.g., a Local Area Network (LAN), a public line, or the Internet.

Referring to FIG. 2, the image forming apparatus 1 is configured of a Central Processing Unit (CPU) 10a, a Random Access Memory (RAM) 10b, a Read-Only Memory (ROM) 10c, a mass storage 10d, a scanner 10e, a printing unit 10f, a network interface 10g, a touch-sensitive panel display 10h, a modem 10i, a finisher 10j, a control circuit, and so on.

The network interface log is a Network Interface Card (NIC) for communicating with another device such as the personal computer 2 via the communication line.

The touch-sensitive panel display 10h displays, for example, a screen for giving a message or instructions to a user, a screen for the user to enter a processing command and processing conditions, and a screen for showing the result of processing performed by the CPU 10a. The touch-sensitive panel display 10h also detects a position thereof touched by the user with his/her finger, and sends a signal indicating the result of the detection to the CPU 10a.

The scanner 10e is a device that reads out images depicted on paper, such as photographs, characters, drawings, diagrams, and the like, and creates image data thereof.

The modem 10i is a device for transmitting image data via a fixed-line telephone network to another facsimile terminal and vice versa based on a protocol such as Group 3 (G3).

The printing unit 10f serves to print, onto paper, an image obtained by scanning with the scanner 10e or an image indicated in image data received from the personal computer 2 or a facsimile terminal.

The finisher 10j serves to apply finishing to a printed matter onto which the printing unit 10f prints an image. The finisher 10j performs, for example, a process for stapling a printed matter, a process for punching a hole in a printed matter, or a process for folding paper in two or three.

The ROM 10c or the mass storage 10d has software such as operating system and middleware installed therein. Modules for forming the software are loaded into the RAM 10b as necessary, and executed by the CPU 10a. An example of the mass storage 10d is a Hard Disk Drive (HDD) or a Solid State Drive (SSD).

Referring to FIG. 3, the personal computer 2 is configured of a CPU 20a, a RAM 20b, a ROM 20c, a mass storage 20d, a keyboard 20e, a pointing device 20f, a liquid crystal display 20g, a network interface 20h, and so on.

The keyboard 20e and the pointing device 20f are devices for a user to enter commands and data into the personal computer 2. An example of the pointing device 20f is a mouse or a track pad.

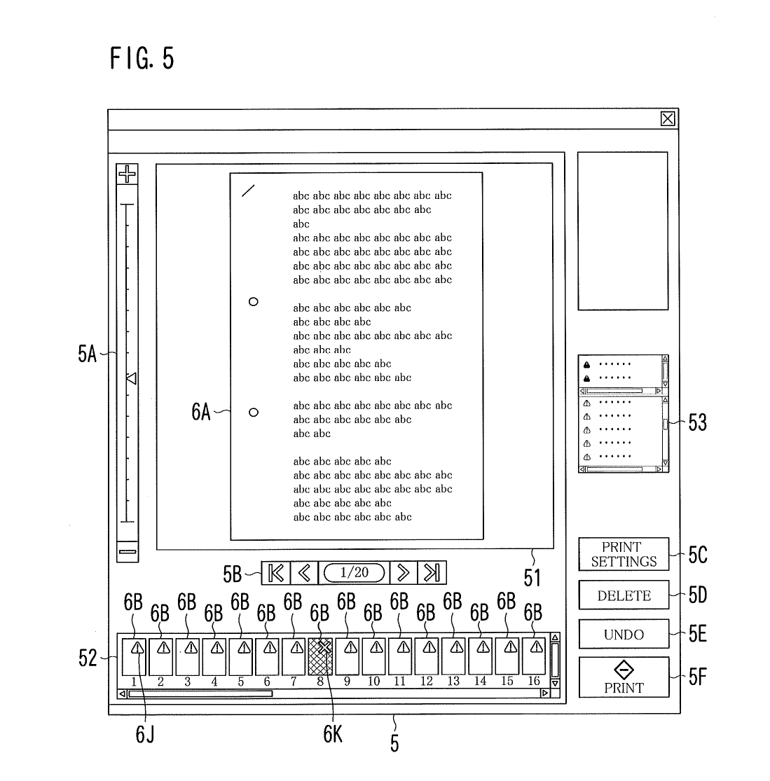

As with the touch-sensitive panel display 10h of the image forming apparatus 1, a variety of screens are displayed on the liquid crystal display 20g. In particular, a print preview window 5 (refer to FIG. 5) is displayed, as one of the screens, on the liquid crystal display 20g.

Referring to FIG. 4, the ROM 20c or the mass storage 20d has installed therein application 2AP such as word processing software, spreadsheet software, or drawing software, and a printer driver 2DR. The application 2AP and the printer driver 2DR are loaded into the RAM 20b as necessary, and executed by the CPU 20a. An example of the mass storage 20d is an HDD or an SSD.

The printer driver 2DR includes modules for implementing the functions of a window display portion 201, a preview image generating portion 202, a preview image storage portion 203, a preview display portion 204, a thumbnail display portion 205, a warning detection portion 211, a warning information storage portion 212, a warning list display portion 213, a warning dialog box display portion 214, a thumbnail controlling portion 231, a print setting portion 241, a print execution portion 242, and so on.

The printer driver 2DR is a program for controlling the image forming apparatus 1. In particular, the printer driver 2DR is a program used to generate print data based on which the image forming apparatus 1 performs printing, and used to send the print data, a command, and so on to the image forming apparatus 1. Further, the printer driver 2DR enables a user to check, on the screen, the appearance of an image to be printed onto paper by the image forming apparatus 1. Displaying the appearance of a finished document is usually called a “preview”. A screen for showing the appearance of such a finished document is usually called a “preview screen”.

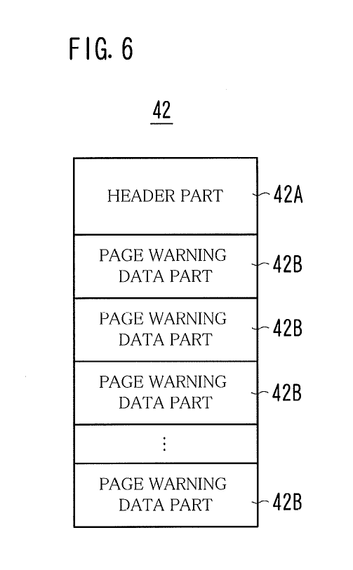

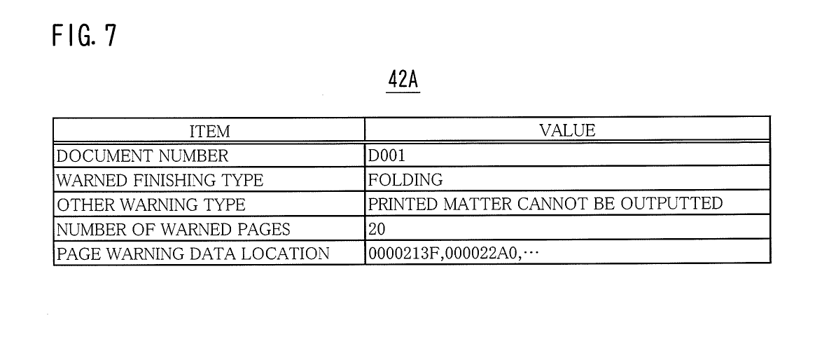

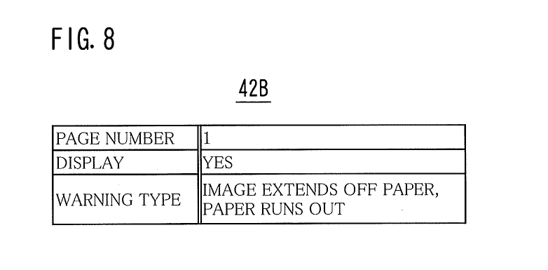

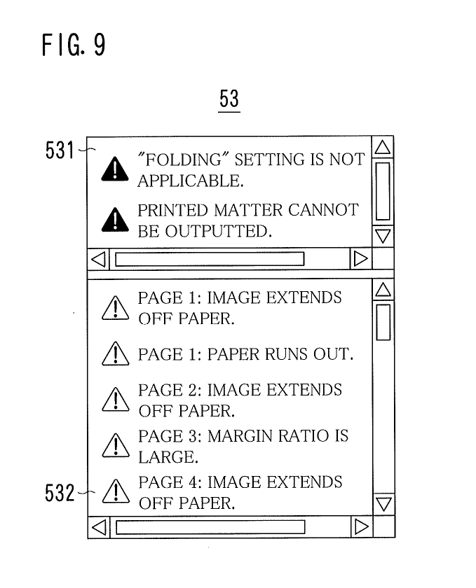

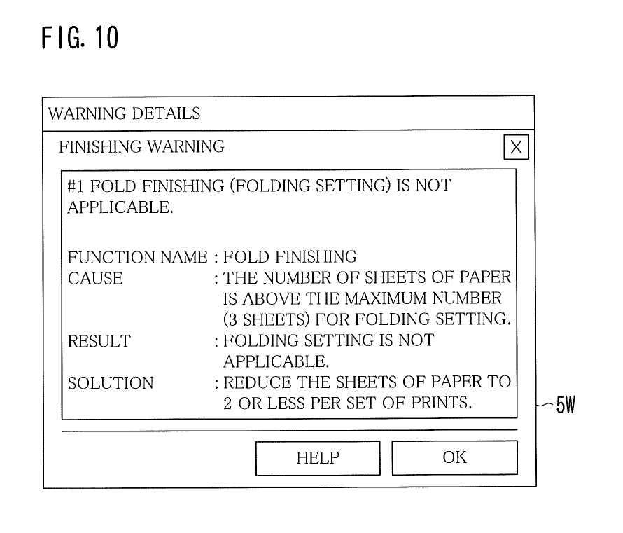

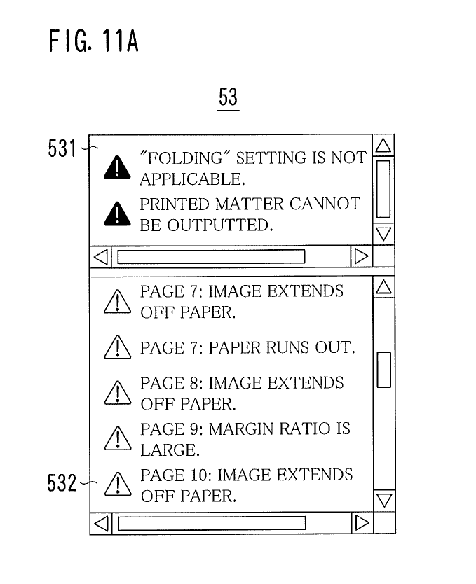

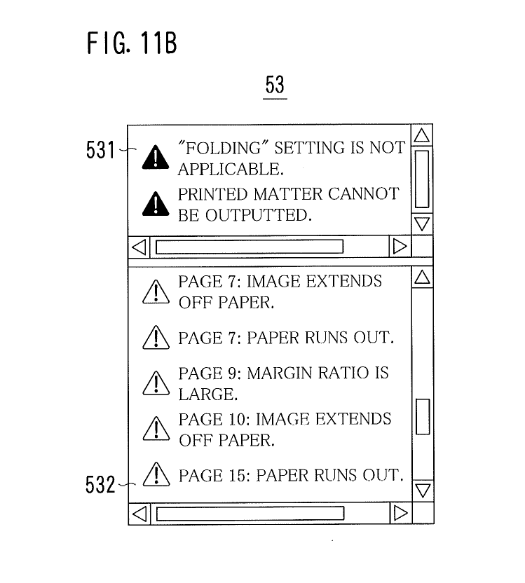

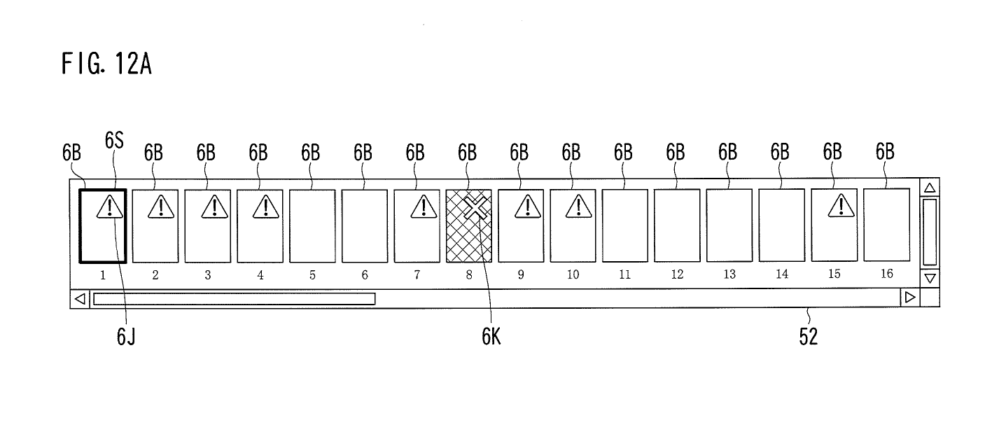

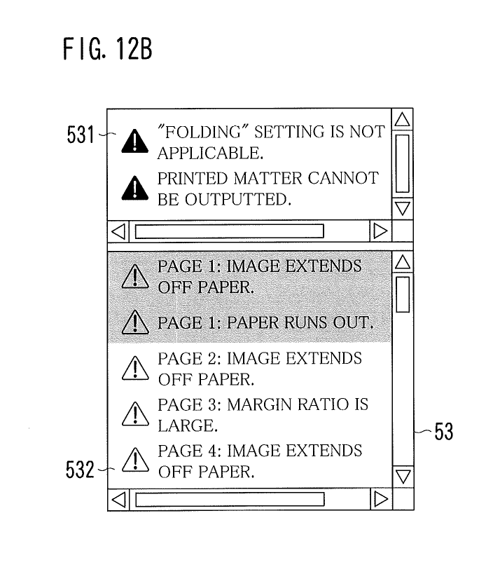

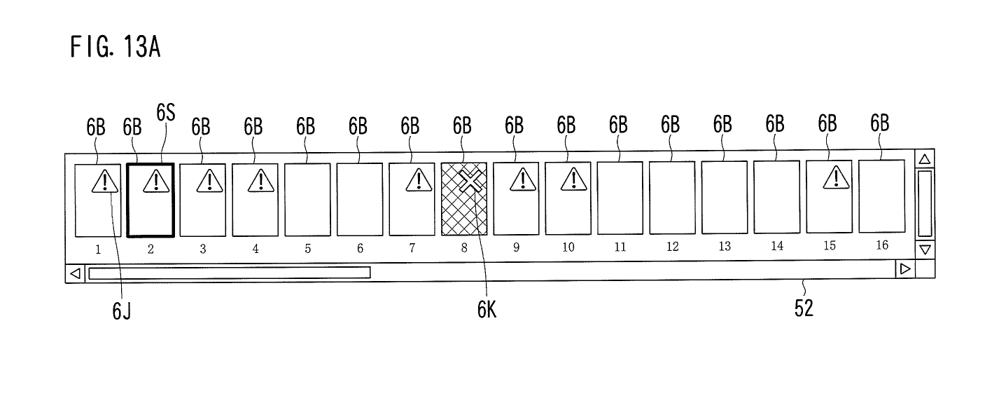

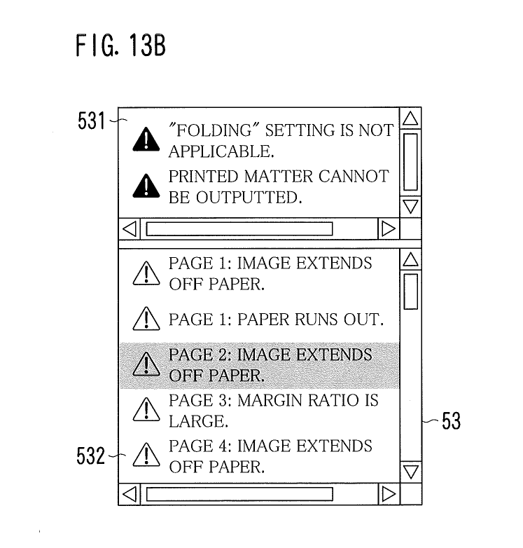

FIG. 5 is a diagram showing an example of the print preview window 5; FIG. 6 is a diagram showing an example of a structure of warning data 42; FIG. 7 is a diagram showing an example of data contained in a header part 42A; FIG. 8 is a diagram showing an example of data contained in a page warning data part 42B; FIG. 9 is a diagram showing an example of a warning message region 53; FIG. 10 is a diagram showing an example of a warning dialog box 5W; FIGS. 11A and 11B are diagrams showing an example of change in the warning message region 53; and FIGS. 12A through 13B are diagrams depicting examples of the movement of a cursor 6S.

Descriptions are provided below of the individual portions of the personal computer 2 shown in FIG. 4.

A user prepares, in the personal computer 2, image data of a document to be printed. The user can prepare such image data by creating a document with the application 2AP. Alternatively, the user may download Web page data from a server on the Internet to use the Web page data as the image data.

The user, then, enters a predetermined command into the personal computer 2. Responsive to this operation, the printer driver 2DR starts up. The following description takes an example in which a print target is a document 6 having a plurality of pages. The user can determine the size of paper to be used for printing on a page-by-page basis.

The window display portion 201 displays the print preview window 5 in the liquid crystal display 20g.

As shown in FIG. 5, the print preview window 5 has a preview image region 51, a thumbnail image region 52, and the warning message region 53. The print preview window 5 also has an enlarge/reduce operation bar 5A, a page selection operation bar 5B, a print settings button 5C, a page delete button 5D, an undo button 5E, and a print command button 5F.

The print setting portion 241 creates setting data indicating the setting details for printing of the document 6, for example, in the following manner.

When the user clicks the print settings button 5C, the print setting portion 241 displays a print settings dialog box in the liquid crystal display 20g. The user enters setting details for a variety of matters in the print settings dialog box. For example, the user enters the presence/absence of finishing to be applied to a printed matter by the finisher 10j. Such finishing is, for example, staple finishing, hole-punch finishing, and fold finishing. The user also enters settings for layout of document pages on a surface of output paper, e.g., a single-sided print mode, a double-sided print mode, or an N-in-i print (N-up print) mode. The user also enters the size of paper used for printing. The user further enters whether printing is to be performed in a color print mode or a monochrome print mode. The user also enters whether or not the image data of the document 6 is saved to the HDD along with the printing.

The print setting portion 241 accepts the details entered by the user to create setting data 41 indicating the details.

The preview image generating portion 202 creates, based on the setting data 41, an preview image 6A and a thumbnail image 6B of each of the pages of the document 6.

The “preview image 6A” is an image showing the appearance of the finished document for a case where the image forming apparatus 1 prints, onto paper, an image depicted on each page of the finished document. The “thumbnail image 6B” is a minified image of an image depicted on each page of the finished document, and has a thumbnail size.

The preview image storage portion 203 stores, in the form of image data, preview images 6A and thumbnail images 6B, of the pages of the document 6, generated by the preview image generating portion 202.

The preview display portion 204 displays a preview image 6A of any page in the preview image region 51 based on the image data stored in the preview image storage portion 203.

When the print preview window 5 is initially displayed, the preview display portion 204 displays a preview image 6A of a default page, e.g., Page 1. When the user operates the page selection operation bar 5B, the preview display portion 204 displays a preview image 6A of another page depending on the operation by the user. Note that, concerning a page for which “No” is set as a value of “display” of the page warning data part 42B (refer to FIG. 8) described later, a preview image 6A of that page is not displayed.

The thumbnail display portion 205 displays thumbnail images 6B of M pages in the thumbnail image region 52 based on the image data stored in the preview image storage portion 203. Note that M is an integer equal to or greater than 2, and M is 16 in this embodiment. When a document 6 has M pages or less, thumbnail images 6B of all the pages of the document 6 are displayed in the thumbnail image region 52. This embodiment describes an example in which the number of pages of a document 6 is more than M.

When the print preview window 5 is initially displayed, the thumbnail display portion 205 displays thumbnail images 6B of, for example, Page 1 through Page M of the document 6. When the user operates a scroll bar provided below the thumbnail image region 52, the thumbnail display portion 205 displays thumbnail images 6B of other pages in accordance with the operation by the user.

The cursor 6S points to any one of the thumbnail images 6B in the thumbnail image region 52. The thumbnail controlling portion 231 displays the cursor 6S, and moves the cursor 6S to a thumbnail image 6B clicked by the user.

The warning detection portion 211 detects (predicts, presumes) states (circumstances, matters) to be informed to the user, e.g., possible problems arising when the document 6 will be printed out. Such states may be classified into states of the entire document 6 and states of the individual pages thereof.

As the states of the entire document 6, the warning detection portion 211 detects states of finishing to be applied to a printed matter. For example, such states include a case (1) where staple finishing is not applicable to a printed matter; a case (2) where hole-punch finishing is not applicable to a printed matter; and a case (3) where fold finishing (two-hold finishing, three-hold finishing, and so on) is not applicable to a printed matter. In addition, the warning detection portion 211 detects (predicts, presumes) states including a case (4) where paper cannot be supplied; a case (5) where a printed matter cannot be outputted; a case (6) where an image on the document 6 cannot be drawn; and a case (7) where image data of the document 6 cannot be saved to the HDD.

As for case (1) described above, it is checked whether or not the number of pages of a printed matter of the document 6 is a predetermined number al or more based on the setting data 41. Thereby, whether or not the staple finishing is applicable to the printed matter can be detected. In short, if the number of pages of the printed matter of the document 6 is the predetermined number al or more, then the warning detection portion 211 detects that the staple finishing is not applicable to the printed matter.

Suppose that, for example, the number of pages of the document 6 is 60, the predetermined number α1 is 25, and the setting data 41 indicates single-sided printing and 2-in-1 printing. In such a case, the number of sheets of paper required for one set of printed matter is 30, which does not fall within the range of 25. Thus, the warning detection portion 211 detects that the staple finishing is not applicable to the printed matter.

Note that the detection for case (1) may be made only when the setting data 41 indicates that staple finishing is necessary. The same is similarly applied to fold finishing, hole-punch finishing, and saving to the HDD, which are described later.

Likewise, as for case (3) described above, it is checked whether or not the number of pages of a printed matter of the document 6 is a predetermined number α2 or more based on the setting data 41. Thereby, whether or not the fold finishing is applicable to the printed matter can be detected.

As for case (2) described above, whether or not hole-punch finishing is applicable to a printed matter can be detected based on a paper size. The warning detection portion 211 detects that the hole-punch finishing cannot be applied to a printed matter when the setting data 41 indicates a paper size equal to or smaller than a predetermined size, e.g., a postcard size.

As for case (4) described above, a comparison is made between the number of sheets of paper of a printed matter of the document 6 and the number of sheets of paper which is in a paper input tray and has a size suitable for printing of the document 6. Thereby, the warning detection portion 211 detects whether or not paper can be supplied. In short, the warning detection portion 211 detects that paper cannot be supplied if the latter is less than the former. The number of sheets of paper of the printed matter of the document 6 and the size of paper to be used for printing are determined with reference to the setting data 41.

As for case (5) described above, it is checked whether or not the number of pages of a printed matter in an output bin is a predetermined number α3 or more. Thereby, whether or not the printed matter can be outputted is detected. In short, if the number of pages of the printed matter in the output bin is the predetermined number α3 or more, then the warning detection portion 211 detects that the printed matter cannot be outputted.

As for case (6) described above, detection is carried out based on the remaining amount of toner. If the remaining amount of toner is less than a predetermined amount, then the warning detection portion 211 detects that the image on the document 6 cannot be drawn.

As for case (7) described above, a comparison is made between the size of image data of the document 6 and an available space of the HDD to which the image data is to be saved. If the former is greater than the latter, then the warning detection portion 211 detects that the image data of the document 6 cannot be saved to the HDD.

As the states of the individual pages of the document 6, the warning detection portion 211 detects (predicts, presumes) various states. For example, such states include a case (8) where a margin ratio is large; a case (9) where an image extends off paper; a case (10) where a letter is small; a case (11) where a letter is large; a case (12) where paper runs out; a case (13) where toner consumption is high; a case (14) where an image is monochrome; a case (15) where a memory area to be used is large; and a case (16) where a memory area to be used is small. Thus, the states of the individual pages of the document 6 are not limited only to the defect-related states.

A method for detecting the foregoing states is described below, taking an example in which states of Page X are detected.

Case (8) described above is detected in the following manner. The warning detection portion 211 calculates, as a margin ratio, a ratio of the sum of areas excluding an object part contained in Page X to the area of paper to be used for printing an image on Page X. If the calculated margin ratio is a predetermined ratio or more, then the warning detection portion 211 detects Case (8), i.e., determines that a margin ratio is large. Note that the object part may be a rectangle encompassing the object.

Case (9) described above is detected as follows. In general, print data to be given to the image forming apparatus 1 contains a code for clip order. The clip order is a command to cut out a print target along a designated boundary. Accordingly, the print data contains a clip order in such a manner that a region for which the image forming apparatus 1 can perform printing is cut out. Hereinafter, such a region is referred to as a “printable region”.

The warning detection portion 211 obtains the print data of the document 6 from the application 2AP, and removes, from the print data, the code for clip order and parameters used together with the code.

The warning detection portion 211 further generates a bitmap of Page X based on the print data. The warning detection portion 211 also checks whether or not the bitmap fits in the printable region. If the bitmap does not fit in the printable region, then the warning detection portion 211 detects the truth.

Case (10) described above is detected in the following manner. A search is made in letters on Page X for a letter having a size smaller than a predetermined size β1. If such a letter is found from the search, then the warning detection portion 211 detects Case (10), i.e., determines that the letter is small.

Case (11) described above is detected in the following manner. A search is made in letters on Page X for a letter having a size larger than a predetermined size β2. If such a letter is found from the search, then the warning detection portion 211 detects Case (11), i.e., determines that the letter is large.

Case (12) described above is detected as follows. It is checked whether or not paper having a size suitable for printing an image on Page X is in the paper input tray. If there is no such paper in the paper input tray, then the warning detection portion 211 detects Case (12), i.e., determines that paper runs out.

Case (13) described above is detected as follows. The total number of pixels of an object contained in Page X is calculated. If the total number thereof is a predetermined number or more, then the warning detection portion 211 detects Case (13), i.e., determines that toner consumption is high.

Case (14) described above is detected in the following manner. The warning detection portion 211 checks colors of pixels of objects contained in Page X. If all the objects contained in Page X are made up of only black pixels although the setting data 41 indicates color printing, the warning detection portion 211 detects Case (14), i.e., determines that the image is a monochrome image.

Case (15) and Case (16) described above are detected based on the size of image data of an image on Page X. If the size is a predetermined size β3 or larger, then the warning detection portion 211 detects Case (15), i.e., determines that the memory area to be used is large. If the size is smaller than a predetermined size β4, then the warning detection portion 211 detects case (16), i.e., determines that the memory area to be used is small.

The warning detection portion 211 detects the states in the foregoing manners, and then, generates warning data 42 indicating the states. The warning data 42 generated is stored into the warning information storage portion 212.

The warning data 42 includes the header part 42A and the page warning data part 42B as shown in FIG. 6. The page warning data part 42B is created by an amount of the number of pages for which the warning detection portion 211 has detected some type of state. For example, if states for 20 pages are detected, then the page warning data parts 42B are created by an amount of 20 pages. Hereinafter, a page for which the warning detection portion 211 has detected some type state is referred to as a “warning required page”.

Referring to FIG. 7, the header part 42A primarily indicates a state of the entire document 6 detected by the warning detection portion 211.

“Document number” shows identification information for distinguishing the subject document 6 from other documents.

“Warned finishing type” shows a state of finishing defect in a printed matter. The following values are used as the warned finishing type. “Stapling” is given for the detection result that staple finishing is not applicable to a printed matter. “Hole-punching” is given for the detection result that hole-punch finishing is not applicable to a printed matter. “Folding” is given for the detection result that fold finishing is not applicable to a printed matter.

“Other warning type” shows a state that is other than the states of finishing defects in a printed matter and is detected by the warning detection portion 211.

“Number of warned pages” shows the total number of pages for which the warning detection portion 211 has detected some sort of state.

As mentioned above, a warning required page is given one page warning data part 42B. “Page warning data location” shows a location, in the warning data 42, of each of the page warning data parts 42B.

Referring to FIG. 8, the page warning data part 42B shows a state of a warning required page.

“Page number” shows the page number of the subject warning required page. “Display” indicates whether or not the subject warning required page is to be previewed. The value of “Yes” is indicated in “display” as the default value. “Warning type” indicates a state detected for the subject warning required page by the warning detection portion 211.

The warning list display portion 213 displays the details of the warning data 42 in the warning message region 53 in the following way.

Referring to FIG. 9, the warning message region 53 contains a document warning region 531 and a page warning region 532. The warning list display portion 213 displays, in one row in the document warning region 531, a warning corresponding to the value of “warned finishing type” of the header part 42A in the warning data 42, and, in another row therein, a warning corresponding to the value of “other warning type” thereof.

The warning list display portion 213 selects, from the warning data 42, only page warning data part 42B (see FIG. 8) having the value “Yes” in “display”. Then, the warning list display portion 213 displays, in one row of the page warning region 532, one by one, warnings corresponding to values indicated in “warning type” of the selected page warning data parts 42B together with values indicated in “page number” thereof. At this time, the warnings are displayed in numerical order of page number. Thus, no warning is displayed for a page corresponding to a page warning data part 42B having the value “No” in “display”.

In this way, states of the entire document 6 are displayed, as a list, in the upper part of the warning message region 53. A state of each of the pages of the document 6 is displayed in numerical order of page number.

When the states of the entire document 6 cannot be displayed at one time in the document warning region 531, the warning list display portion 213 displays only a part of the same. Then, responsive to operation of a scroll bar, the warning list display portion 213 scrolls the indication and displays the remaining states in due order. The same is similarly applied to the state of each of the pages of the document 6.

The thumbnail display portion 205 adds, to a thumbnail image 6B of the warning required page, a warning icon 6J indicating the presence of warning. An example of the warning icon 6J is an exclamation mark icon.

The thumbnail controlling portion 231 performs various control operation related to display of the thumbnail image 6B. This will be described in order below.

When any one of the rows in the document warning region 531 or in the page warning region 532 is selected, the warning dialog box display portion 214 displays, on the print preview window 5, a warning dialog box 5W indicating the warning details corresponding to the selected row.

As shown in FIG. 10, the warning dialog box 5W contains information indicating the name of a function (function name) relating to the warning indicated in the selected row, the cause of a defect of the function, an expected result if processing is executed with the current settings being active, a solution to the defect (countermeasure), and so on. Note that the details indicated in the warning dialog box 5W may be registered in advance in a database on a warning-by-warning basis.

When a close button on the upper right of the warning dialog box 5W is pressed, the warning dialog box display portion 214 closes the warning dialog box 5W accordingly.

A user can set again the details for printing of the entire document 6 or each of the pages thereof with reference to the details displayed in the warning message region 53 or the warning dialog box 5W. The setting operation and the setting processing are the same as those discussed earlier. Alternatively, the user may modify the details of the document 6 and perform again operation from the start operation of the printer driver 2DR.

The user can also exclude a defective page from the print target. In such a case, the user selects the defective page by moving the cursor 6S to a thumbnail image 6B of the defective page. Responsive to this operation, the warning list display portion 213 displays a state of the defective page in the page warning region 532. The user, then, clicks the page delete button 5D of the print preview window 5 and other operation to enter a delete command.

Responsive to this operation, the warning information storage portion 212 changes the value in “display” of the page warning data part 42B of the defective page from “Yes” to “No”.

In relation to the change, the thumbnail controlling portion 231, the warning list display portion 213, and the preview display portion 204 control an object in the print preview window 5 in the following manner.

The thumbnail controlling portion 231 adds, to a thumbnail image 6B of the defective page, a delete icon 6K indicating that the corresponding page is excluded from the display targets. An example of the delete icon 6K is an “X” mark icon. At this time, displaying the warning icon 6J that was previously added to the thumbnail image 6B of the defective page is cancelled.

The warning list display portion 213 stops displaying the warning message for the defective page in the warning message region 53. To be specific, when the defective page is Page 8, for example, what is displayed in the warning message region 53 changes from the indication shown in FIG. 11A to that in FIG. 11B.

Even if the page selection operation bar 5B of the print preview window 5 is operated, and if the turn of the defective page comes, the preview display portion 204 omits the indication of the preview image 6A of the defective page, and displays another preview image 6A of the previous page or the subsequent page.

The user can bring a page that has been excluded from the print targets into the print targets again. In such a case, the user selects the page by clicking a thumbnail image 6B of the page or other operation. Then, the user clicks the undo button 5E and other operation to enter an undo command.

Responsive to this operation, the warning information storage portion 212 changes the value in “display” of the page warning data part 42B of the defective page from “No” to “Yes”.

In relation to the change, the thumbnail controlling portion 231, the warning list display portion 213, and the preview display portion 204 control an object in the print preview window 5 in the following manner.

The thumbnail controlling portion 231 deletes the delete icon 6K from the thumbnail image 6B of the defective page, and adds again the warning icon 6J to the thumbnail image 6B thereof.

The warning list display portion 213 resumes displaying the warning message for the defective page in the warning message region 53.

When the page selection operation bar 5B of the print preview window 5 is operated, and the turn of the page comes, the preview display portion 204 displays the preview image 6A of the defective page without omitting the indication thereof.

When the print command button 5F is clicked, the print execution portion 242 creates print data 43 for printing the document 6 except for a page having the value “No” in “display” of the page warning data part 42B, and sends the created print data 43 to the image forming apparatus 1 together with a print command. Note that, when the print data 43 is created, the details set in the setting data 41 are reflected in the print data 43. It is also possible to send the setting data 41 to the image forming apparatus 1 together with the print data 43.

When any one of the rows in the page warning region 532 is selected, the thumbnail controlling portion 231 places the cursor 6S into a thumbnail image 6B of a page corresponding to the selected row. Suppose that, for example, the cursor 6S is placed into the thumbnail image 6B of Page 1 as shown in FIG. 12A. In such a case, when a row corresponding to a warning message for Page 2 is selected as shown in FIG. 13B, the thumbnail controlling portion 231 moves the cursor 6S to a thumbnail image 6B of Page 2 as shown in FIG. 13A. It is possible to indicate the selected row differently from the indication of the other rows. For example, the background color of the selected row is changed to gray. If there are a plurality of rows corresponding to one page, it is possible to change the indication not only of the selected row but of the rest rows of that page.

Further, the preview display portion 204 displays the preview image 6A of the page corresponding to the selected row in the preview image region 51.

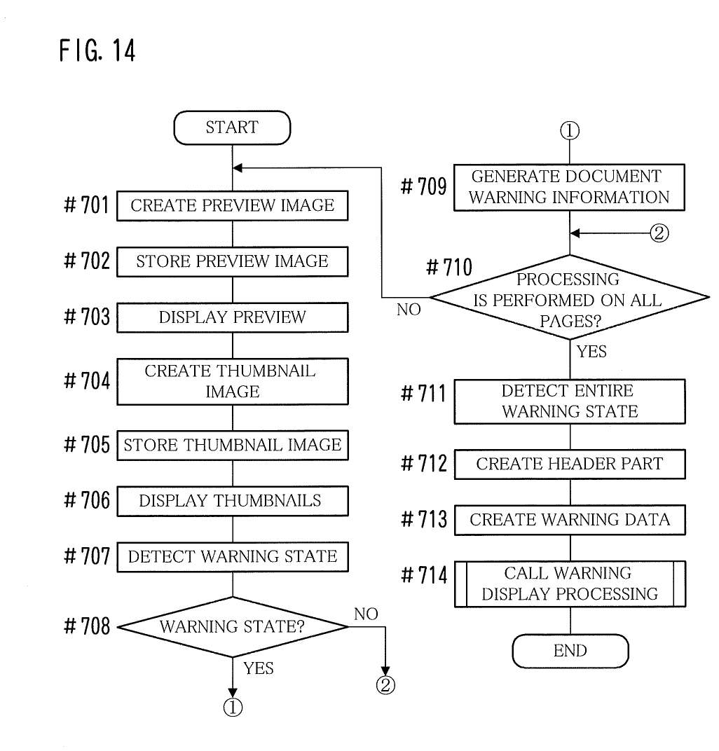

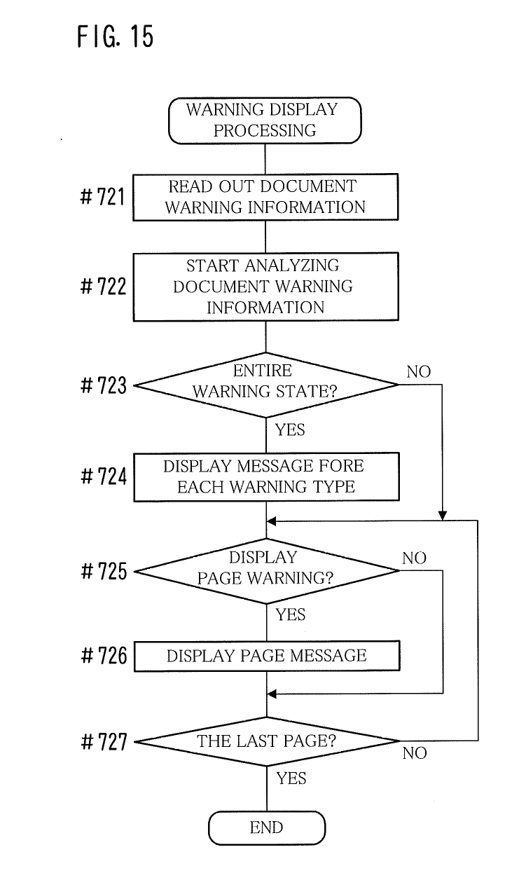

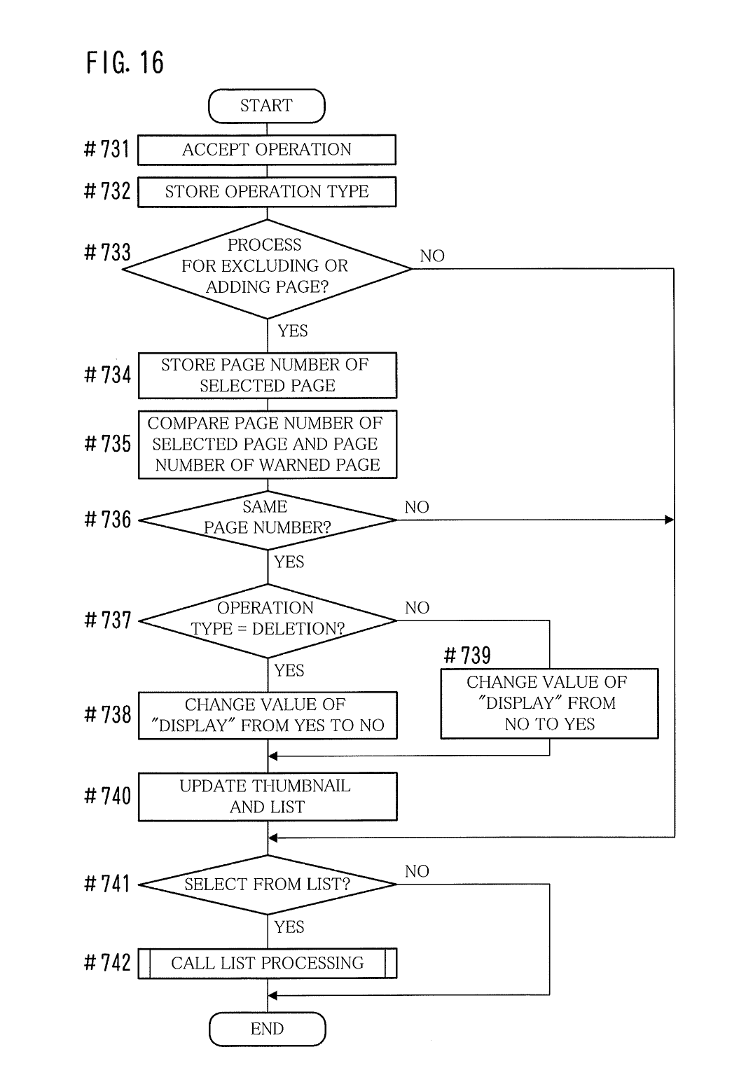

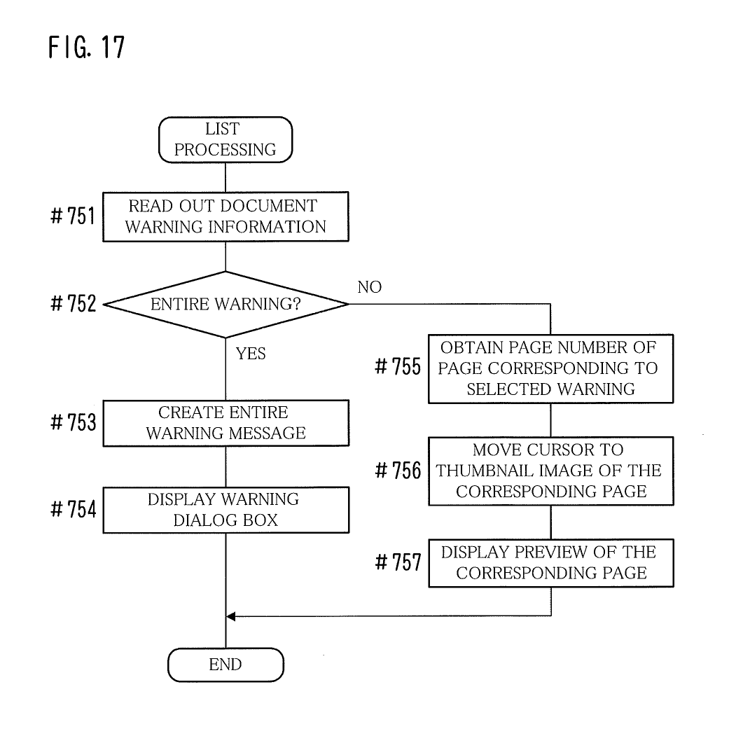

FIG. 14 is a flowchart depicting an example of the flow of processing performed when the print preview window 5 is displayed; FIG. 15 is a flowchart depicting an example of the flow of warning display processing; FIG. 16 is a flowchart depicting an example of the flow of processing performed after the print preview window 5 is displayed; and FIG. 17 is a flowchart depicting an example of the flow of list processing.

Descriptions are provided below of the entire processing flow related to a preview by the personal computer 2 with reference to the flowcharts of FIG. 14 and so on.

The personal computer 2 creates a preview image 6A (see FIG. 5) of Page 1 of a document 6 (Step #701 in FIG. 14), and stores the same (Step #702). The personal computer 2, then, displays the preview image 6A in the preview image region 51 (Step #703).

In parallel with the processing for creating the preview image 6A and so on, or before or after the same, the personal computer 2 creates a thumbnail image 6B of Page 1 (Step #704) and stores the same (Step #705). The personal computer 2, then, displays the thumbnail image 6B in the thumbnail image region 52 (Step #706).

In parallel with the processing for creating the preview image 6A and the processing for creating the thumbnail image 6B, and before or after the same, the personal computer 2 performs processing for detecting a state of Page 1 to draw user's attention (Step #707). If some type of state is detected (Yes in Step #708), then the personal computer 2 creates a page warning data part 42B (see FIG. 8) indicating the details of the state and so on (Step #709).

Likewise, the personal computer 2 creates a preview image 6A and a thumbnail image 6B of Page 2 and beyond (Step #701 through Step #706), and detects a state to call user's attention, and so on (Step #707 through Step #709). Note that the number of preview images 6A displayable in the preview image region 51, and the number of thumbnail images 6B displayable in the thumbnail image region 52 are limited. Accordingly, if a preview image 6A of another page is already displayed in the preview image region 51, then the personal computer 2 bypasses the processing in Step #703. Further, if the thumbnail image region 52 is full with thumbnail images 6B of other pages, then the personal computer 2 bypasses the processing in Step #706.

If the foregoing processing is completely performed on all the pages of the document 6 (Yes in Step #710), then the personal computer 2 detects a state of the entire document 6 to be informed to the user (Step #711), and creates a header part 42A (see FIG. 7) (Step #712). The personal computer 2, then, creates warning data 42 (see FIG. 6) by using the header part 42A and the page warning data part 42B (Step #713).

Subsequently, the personal computer 2 calls a module for performing warning display processing (Step #714).

Referring to FIG. 15, the personal computer 2 reads out the warning data 42 (Step #721) to start analyzing the details of the warning data 42 (Step #722).

If the warning data 42 indicates a state of the entire document 6 (Yes in Step #723), then the personal computer 2 displays the warning messages showing the states in the document warning region 531 (see FIG. 9) (Step #724).

If the warning data 42 indicates states of each of the pages of the document 6 (Yes in Step #725), then the personal computer 2 displays the warning messages showing each of the states in the page warning region 532 (see FIG. 9) in numerical order of page number (Step #726). After finishing such display in the page warning region 532 (Yes in Step #727), the personal computer 2 finishes the warning display processing.

Further, the personal computer 2 performs the processing in accordance with operation by the user in the manner shown in FIGS. 16 and 17.

When accepting the details of the operation (Step #731 in FIG. 16), the personal computer 2 stores the same thereinto (Step #732).

If the operation is to exclude a page from the print target or to add a page to the print target (Yes in Step #733), then the personal computer 2 stores, thereinto, the page number of the page designated by the user (Step #734).

The personal computer 2 checks the page number of the page designated by the user against the page number of each page for which a state has been detected, i.e., against the page number indicated in each of the page warning data parts 42B (Step #735). If a match is found between the page number of the page designated by the user and any one of the page numbers of the pages for which a state has been detected (Yes in Step #736), then the personal computer 2 updates the value in “display” of the page warning data part 42B of the page designated by the user in the following manner. If the user has clicked the page delete button 5D of the print preview window 5 (Yes in Step #737), then the personal computer 2 updates the value in “display” from “Yes” to “No” (Step #738). On the other hand, if the user has clicked the undo button 5E of the print preview window 5 (No in Step #737), then the personal computer 2 updates the value in “display” from “No” to “Yes” (Step #739).

Subsequently, the personal computer 2 updates the list in the warning message region 53 and an icon added to the thumbnail image 6B (Step #740).

Alternatively, if the operation by the user is to select any one of rows of the list in the warning message region 53 (Yes in Step #741), then the personal computer 2 calls a module for control processing on thumbnails or a module for display processing of the warning dialog box 5W (Step #742).

Referring to FIG. 17, the personal computer 2 reads out the warning data 42 (Step #751).

If any one of the rows is selected in the document warning region 531 (Yes in Step #752), then the personal computer 2 creates a warning message for the selected row (Step #753), and displays a warning dialog box 5W (see FIG. 10) indicating the message (Step #754).

On the other hand, if any one of the rows is selected in the page warning region 532 (No in Step #752), then the personal computer 2 obtains (identifies) the page number of the page corresponding to the selected row (Step #755). Then, the personal computer 2 moves the cursor 6S to a thumbnail image 6B of the page (Step #756) and displays a preview image 6A of the page in the preview image region 51 (Step #757).

The first embodiment enables a user to check a document more easily than is conventionally possible even if the document has a plurality of pages.

The first embodiment is directed to a case of detecting (predicting) a possible state found in a document for a case where a multi-functional image forming apparatus such as an MFP prints out the document. The present invention is also applicable to a case of detection of a possible state found in a document for a case where a dedicated printer (a printer connected to a personal computer through a USB cable or a Bluetooth) performs printing.

In the first embodiment, it is a personal computer 2 that displays the print preview window 5, i.e., performs a preview display. Instead of this, however, the image forming apparatus 1 may perform such a display. In such a case, the image forming apparatus 1 may be provided with modules for implementing the functions of the window display portion 201, the preview image generating portion 202, the preview image storage portion 203, the preview display portion 204, the thumbnail display portion 205, the warning detection portion 211, the warning information storage portion 212, the warning list display portion 213, the warning dialog box display portion 214, the thumbnail controlling portion 231, a warning information storage portion 232, a warning display portion 233, and a print setting portion 241, all of which are shown in FIG. 4. Then, the print preview window 5 may be displayed in the touch-sensitive panel display 10h instead of being displayed in the liquid crystal display 20g.

### Second Embodiment

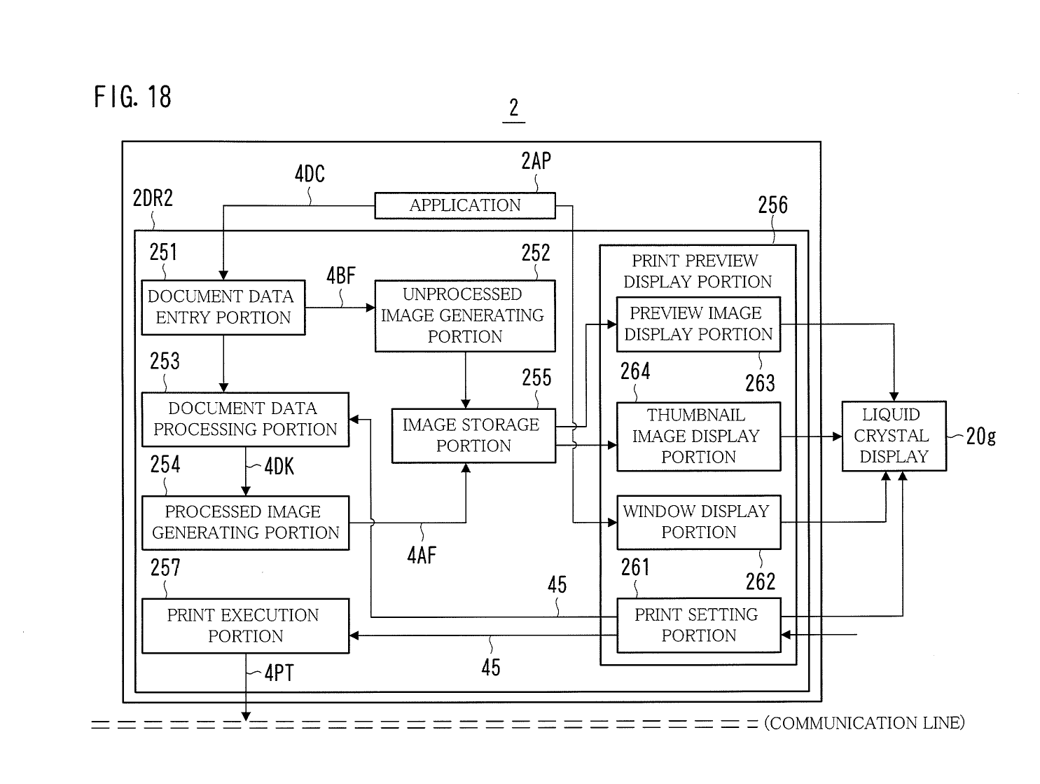

FIG. 18 is a diagram showing a modified example of the functional configuration of a personal computer 2.

In the first embodiment, detection is made of the entire state probably found in the entire printed matter, and individual states probably found in the individual pages of the printed matter. Then, the entire state and the individual states are laid out in one screen for display.

In the second embodiment, as page images, a preview image showing an image that has been subjected to specific processing and an image that has not yet been subjected to the specific processing are displayed on one screen.

The entire configuration of a network system 100 according to the second embodiment is the same as that of the network system 100 according to the first embodiment (see FIG. 1). The hardware configuration of an image forming apparatus 1 according to the second embodiment is also the same as that of the image forming apparatus 1 according to the first embodiment (see FIG. 2). The hardware configuration of a personal computer 2 according to the second embodiment is also the same as that of the personal computer 2 according to the first embodiment (see FIG. 3).

However, a ROM 20c or a mass storage 20d according to the second embodiment has installed therein a printer driver 2DR2 as shown in FIG. 18, instead of the printer driver 2DR (see FIG. 4). As with the first embodiment, application 2AP is installed into the ROM 20c or the mass storage 20d. The application 2AP and the printer driver 2DR2 are loaded into a RAM 20b as necessary, and executed by a CPU 20a.

The printer driver 2DR includes modules for implementing the functions of a document data entry portion 251, a unprocessed image generating portion 252, a document data processing portion 253, a processed image generating portion 254, an image storage portion 255, a print preview display portion 256, a print execution portion 257, and so on, all of which are shown in FIG. 18.

The print preview display portion 256 includes a print setting portion 261, a window display portion 262, a preview image display portion 263, and a thumbnail image display portion 264.

The printer driver 2DR2 is a program for controlling the image forming apparatus 1. In particular, the printer driver 2DR2 is a program used to generate print data based on which the image forming apparatus 1 performs printing, or a program used to send the print data, a command, and so on to the image forming apparatus 1. Further, the printer driver 2DR2 enables a user to check, on the screen, the appearance of an image to be printed onto paper by the image forming apparatus 1.

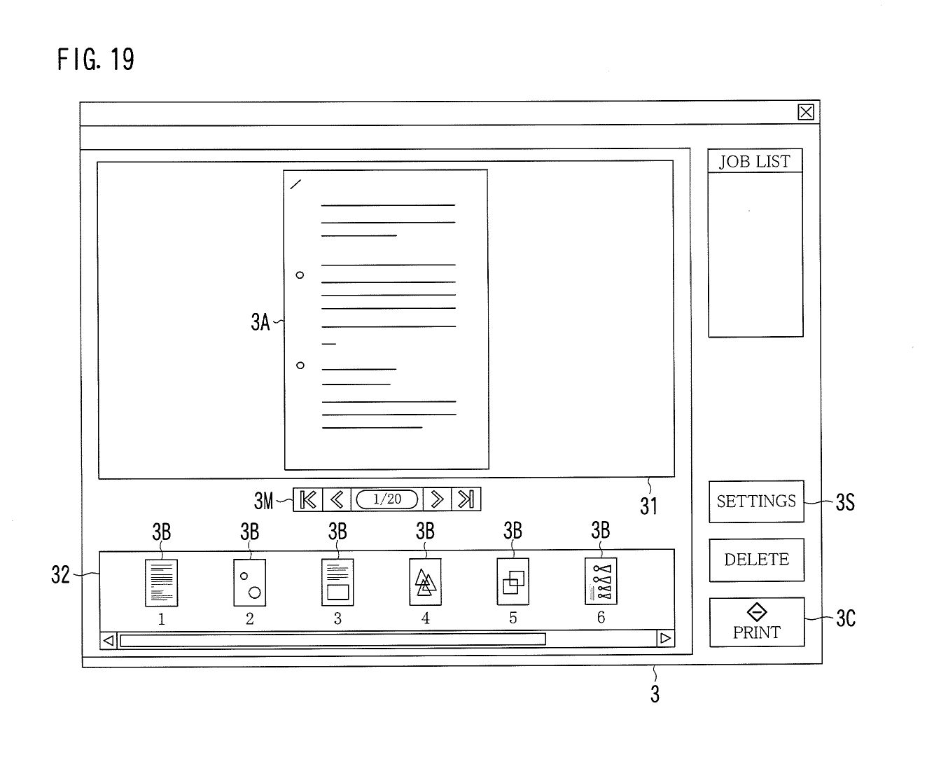

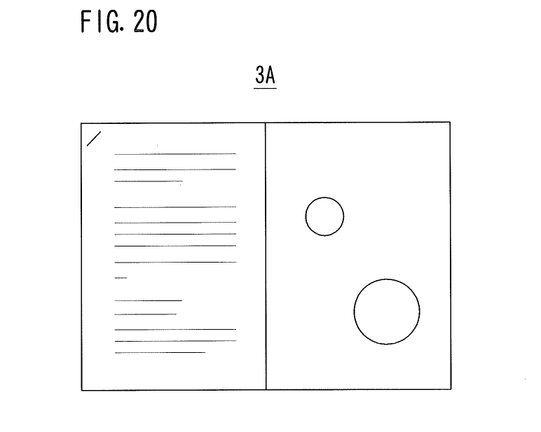

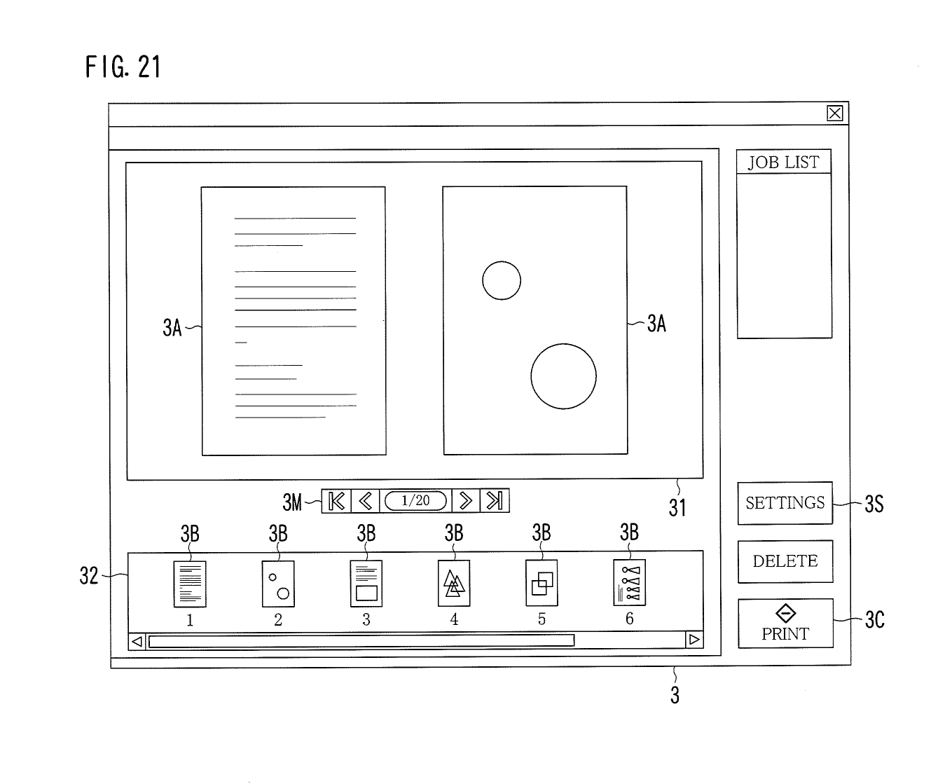

FIG. 19 is a diagram showing an example of a print preview window 3; FIG. 20 is a diagram showing an example of a preview image 3A for 2-in-1 printing; and FIG. 21 is a diagram showing an example of a print preview window 3.

Descriptions are provided in due order of the individual portions of the printer driver 2DR2 of the personal computer 2 shown in FIG. 18.

A user prepares, in the personal computer 2, data of a document to be printed. The user can prepare such data by creating a document with the application 2AP. Alternatively, the user may prepare the data by downloading the data from a Web server on the Internet.

The user, then, enters a print command into the personal computer 2. Responsive to this operation, the printer driver 2DR2 starts up. The following description takes an example of the case where a print target is a document 6 having a plurality of pages.

The window display portion 262 displays the print preview window 3 in the liquid crystal display 20g.

As shown in FIG. 19, the print preview window 3 has a preview image region 31 and a thumbnail image region 32. The print preview window 3 also has a page selection operation bar 3M, a print settings button 3S, and a print command button 3C.

The print setting portion 261 creates setting data indicating the setting details for printing the document 6, for example, in the following manner.

When the user clicks the print settings button 3S, the print setting portion 261 displays a print settings dialog box in the liquid crystal display 20g.

The user enters setting details for processing or editing to be performed on the document or a printed matter thereof. For example, the user enters the presence/absence of finishing to be applied to a printed matter by the finisher 10j. Such finishing is, for example, staple finishing and hole-punch finishing. The user also enters settings for layout of document pages in output paper. To be specific, images on the document pages are to be printed in a single-sided print mode, a double-sided print mode, an N-in-1 print (N-up print) mode, or a booklet mode. The user also enters information on a page to be inserted between two adjacent pages. The user also enters whether printing is to be carried out in a color print mode or a monochrome print mode.

The print setting portion 261 accepts the details entered by the user to create setting data 45 indicating the details.

The document data entry portion 251 obtains data on the document 6 from the application 2AP. Hereinafter, the data is referred to as “document data 4DC”.

The unprocessed image generating portion 252 creates bitmapped image data for each page of the document 6 by performing rasterization based on the document data 4DC without applying the details indicated in the setting data 45, i.e., without performing the processing and editing designated by the user. Hereinafter, such bitmapped image data is referred to as “unprocessed image data 4BF”. As described earlier, the document 6 has a plurality of pages. Accordingly, the unprocessed image generating portion 252 creates a plurality of sets of unprocessed image data 4BF.

The document data processing portion 253 processes the document data 4DC by inserting a specific command or changing parameter values so that the document 6 is printed out and finishing is applied to a printed matter based on the details of the setting data 45.

Hereinafter, the document data 4DC that has been subject to the processing is referred to as “processed document data 4DK”.

The processed image generating portion 254 creates image data of an image showing, on-paper-by-paper basis, the appearance of an image of the printed matter of the document 6 by performing rasterization based on the processed document data 4DK. Hereinafter, such an image is referred to as a “preview image 3A”, and such image data is referred to as “processed image data 4AF”.

For double-sided printing, the processed image generating portion 254 creates processed image data 4AF of a preview image 3A depicted on each side of paper. Hereinafter, a side of paper onto which an image is to be printed is called a “print side”. Only the obverse surface of paper is a print side for one-sided printing. Both the obverse and reverse surfaces of paper are print sides for double-sided printing.

As discussed above, the details contained in the setting data 45 are applied to the processed document data 4DK. Accordingly, when setting is so made that a plurality of pages are laid out on a sheet of paper, one preview image 3A contains images of the plurality of pages.

The processed image generating portion 254 also adds, to a preview image 3A, an image for a case where staple finishing or hole-punch finishing is to be applied to a printed matter depending on the details of finishing settings.

In the case, for example, where 2-in-1 printing and staple finishing are set, the processed image generating portion 254 creates processed image data 4AF of a preview image 3A as that shown in FIG. 20.

In the case, for example, where setting is so made that a blank page (white page) is inserted into two adjacent pages, the processed image generating portion 254 creates a preview image 3A showing such appearance that a blank page is inserted between both the pages.

The image storage portion 255 stores, therein, the unprocessed image data 4BF and processed image data 4AF thus created.

The preview image display portion 263 displays, in the preview image region 31, a preview image 3A of each print side of each sheet of paper of a printed matter based on the processed image data 4AF stored in the image storage portion 255.

When the print preview window 3 is initially displayed, the preview image display portion 263 displays a preview image 3A of a print side designated in the default order, e.g., the obverse surface of the first sheet of paper. Responsive to operation of the page selection operation bar 3M by the user, the preview image display portion 263 displays a preview image 3A of another print side in accordance with the operation by the user.

If the preview image region 31 has a sufficient area, then preview images 3A of a plurality of print sides may be displayed side by side therein.

The thumbnail image display portion 264 reduces an image that has not been subjected to both processing and editing of each page of the document 6 to an image having a size of icon or thumb based on the unprocessed image data 4BF stored in the image storage portion 255, and displays the resultant image in the thumbnail image region 32. Hereinafter, the resultant image is referred to as a “thumbnail image 3B”.

When the print preview window 3 is initially displayed, the thumbnail image display portion 264 displays thumbnail images 3B of pages as much as possible in order starting from Page 1 of the document 6. Responsive to operation, by the user, of a scroll bar provided below the thumbnail image region 32, the thumbnail image display portion 264 displays thumbnail images 3B of the rest pages of the document 6 in accordance with the operation by the user.

Responsive to the print command button 3C being clicked, the print execution portion 257 generates print data 4PT used for printing the document 6 based on the document data 4DC. The print execution portion 257, then, sends the print data 4PT to the image forming apparatus 1 designated by the user together with a print command. Note that, for generation of the print data 4PT, the setting details indicated in the setting data 45 are reflected. Alternatively, the setting data 45 may be sent to the image forming apparatus 1 together with the print data 4PT.

Subsequently, the image forming apparatus 1 prints an image of the document 6 onto paper in accordance with the details of the setting data 45.

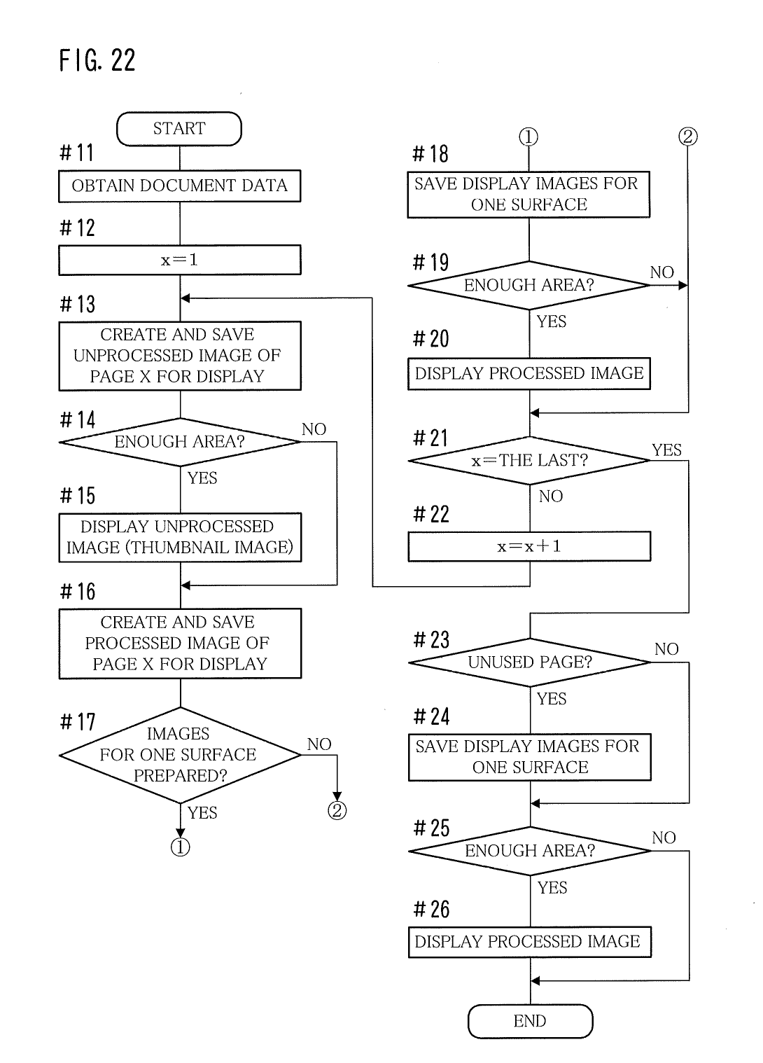

FIG. 22 is a flowchart depicting an example of the flow of processing performed when the print preview window 3 is displayed.

Descriptions are provided below of the entire processing flow related to a preview by the printer driver 2DR2 with reference to the flowcharts of FIG. 22 and so on.

After the printer driver 2DR2 starts up, the personal computer 2 displays the print preview window 3 (see FIG. 19), and obtains document data 4DC and setting data 45 (Step #11 in FIG. 22). The personal computer 2 generates data of Page 1 that has not yet been subjected to processing and editing, i.e., unprocessed image data 4BF, and saves the same (Step #13).

If the thumbnail image region 32 has an extra area having a predetermined size or larger (Yes in Step #14), then the personal computer 2 displays a thumbnail image 3B of Page 1 in the thumbnail image region 32 (Step #15).

In parallel with the process from Step #13 through Step #15, and before or after the same, the personal computer 2 creates image data of Page 1 that has been subjected to the processing and the editing (Step #16).

If all sets of image data of pages that are to be laid out on a print side on which image data of Page 1 is laid out are prepared (Yes in Step #17), then the personal computer 2 creates data of a preview image 3A of this print side, i.e., processed image data 4AF, and saves the same (Step #18).

If a setting is so made that an image of one page is laid out on one print side of paper, then the process always advances to “Yes” in Step #17. On the other hand, if a setting is so made that images of a plurality of pages are laid out on one print side of paper, then the process advances to “Yes” or “No” in Step #17.

If the preview image region 31 has an extra area having a predetermined size or larger (Yes in Step #19), then the personal computer 2 displays the preview image 3A generated in Step #18 in the preview image region 31 (Step #20).

The personal computer 2 performs the process from Step #13 through Step #20 on Page 2 and beyond.

The thumbnail images 3B are laid out in the order that the thumbnail images 3B have been generated from the left of the thumbnail image region 32. Likewise, the preview images 3A are laid out in the order that the preview images 3A have been generated from the left of the preview image region 31.

According to the process from Step #13 through Step #22, when a setting is so made that images on M pages (M≧2) are laid out on one print side, in principle, images on all the pages are contained in any of preview images 3A as long as the number of pages of the document 6 is a multiple of M.

However, if the number of pages of the document 6 is not a multiple of M, then images on the first page through the (M-1)-th page from the last page of the document 6 are sometimes not contained in any of the preview images 3A. Stated differently, such images are sometime left behind.

To cope with this, if images on one page through (M-1) page from the last page of the document 6 are left behind (Yes in Step #23), then the personal computer 2 generates processed image data 4AF of a preview image 3A in which the left-behind images are laid out in accordance with the settings, and saves the processed image data 4AF (Step #24). Further, if the preview image region 31 has an extra area (Yes in Step #25), then the personal computer 2 displays the preview image 3A (Step #26).

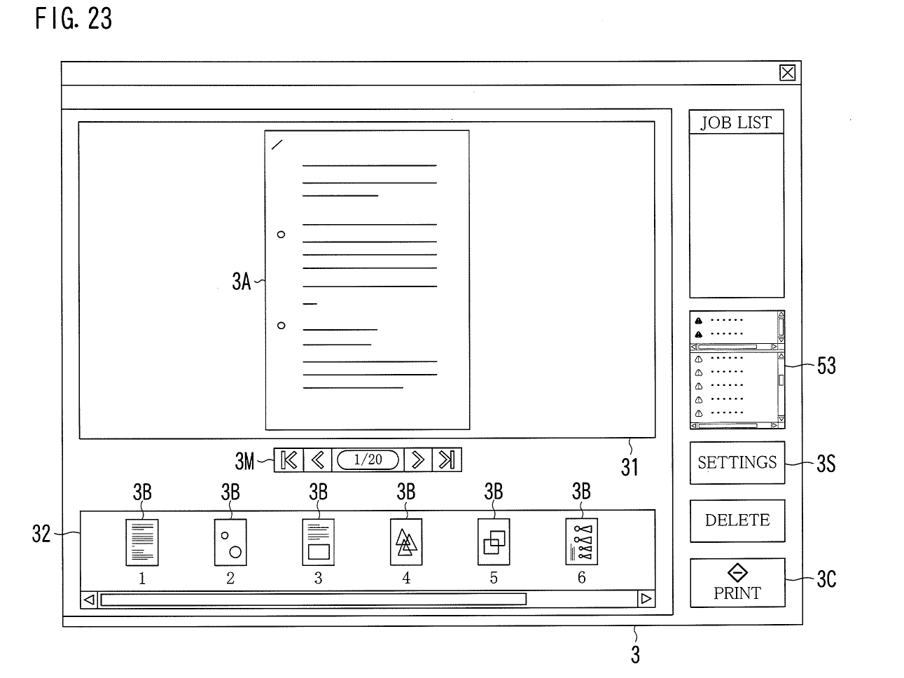

FIG. 23 is a diagram showing an example of a print preview window 3 in which a warning message region 53 is provided.

As with the print preview window 5 (see FIG. 5) of the first embodiment, the print preview window 3 may be provided with the warning message region 53 as shown in FIG. 23. As discussed earlier with reference to FIGS. 9, 11-13, and 15-17, the warning message region 53 shows a list of a state of the entire document 6 and a state of each of the pages of the document 6. A method for displaying the list and a method for detecting such states are the same as those of the first embodiment. Further, the warning message region 53, a cursor, the preview image 3A, and the thumbnail image 3B may cooperate with one another in a manner similar to that of the first embodiment.

In order to provide the warning message region 53, modules for implementing the functions of the warning detection portion 211, the warning information storage portion 212, the warning list display portion 213, and so on of the first embodiment may be added to the printer driver 2DR2. A time at which a state is detected and displayed may be an arbitrary time. For example, the time may be immediately after a preview image 3A is generated (around Step #18 in FIG. 22). The same is similarly applied to the following specific example.

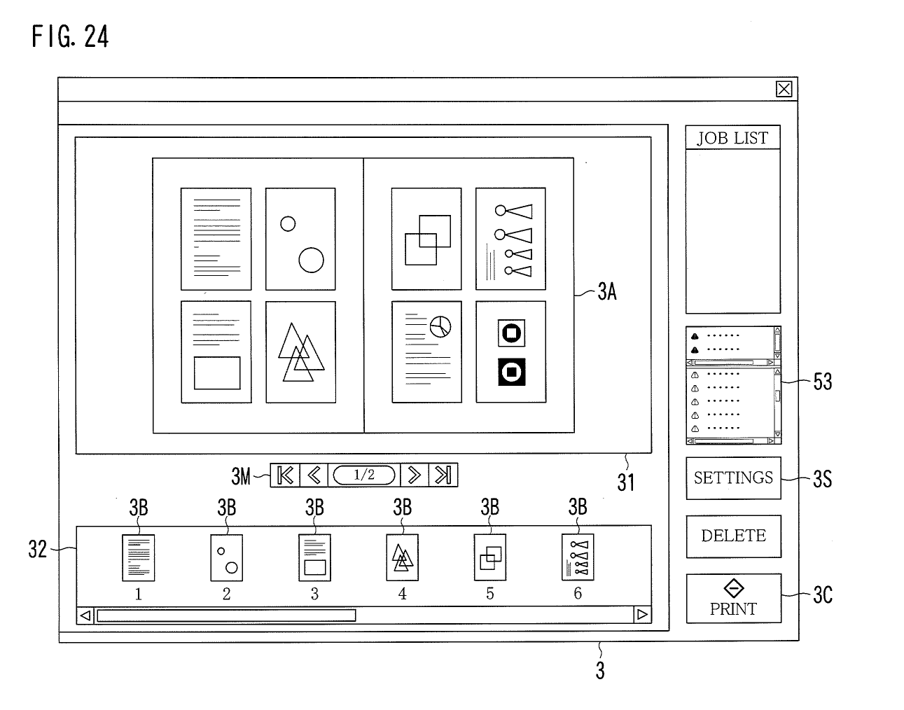

FIG. 24 through FIG. 27 are diagrams showing examples of the print preview window 3. Specific examples of a preview are provided below by taking examples of the document 6, settings, and so on.

Suppose that, for example, the number of pages of the document 6 is 16, and settings of 4-in-1 printing and booklet printing are made. In such a case, the personal computer 2 displays a preview image 3A and thumbnail images 3B, as shown in FIG. 24, in such a manner that images of four pages of the document 6 are laid out in the order of page number on the half surface of a printed matter each by folding the printed matter. In the illustrated example of FIG. 24, the page images are laid out in the order of upper left, upper right, lower left, and lower right. The order may be, however, upper left, lower left, upper right, and lower right. Which order is to be applied may be determined by the user.

In the meantime, there is a case in which a user is allowed to make settings of N-in-1 printing not for the printer driver 2DR2 but for the application 2AP. In such a case, the application 2AP reduces the individual images of N pages and bring the resultant images together into one page, so that document data 4DC is created.

A user sometimes gives a print command without knowing such settings made for the application 2AP. This often happens for a case where N-in-1 print settings previously made remain active. Assume that, for example, the number of original pages of the document 6 is 8, and 2-in-1 printing is erroneously set for the application 2AP. Then, 2-in-1 printing and booklet printing are set for the printer driver 2DR2.

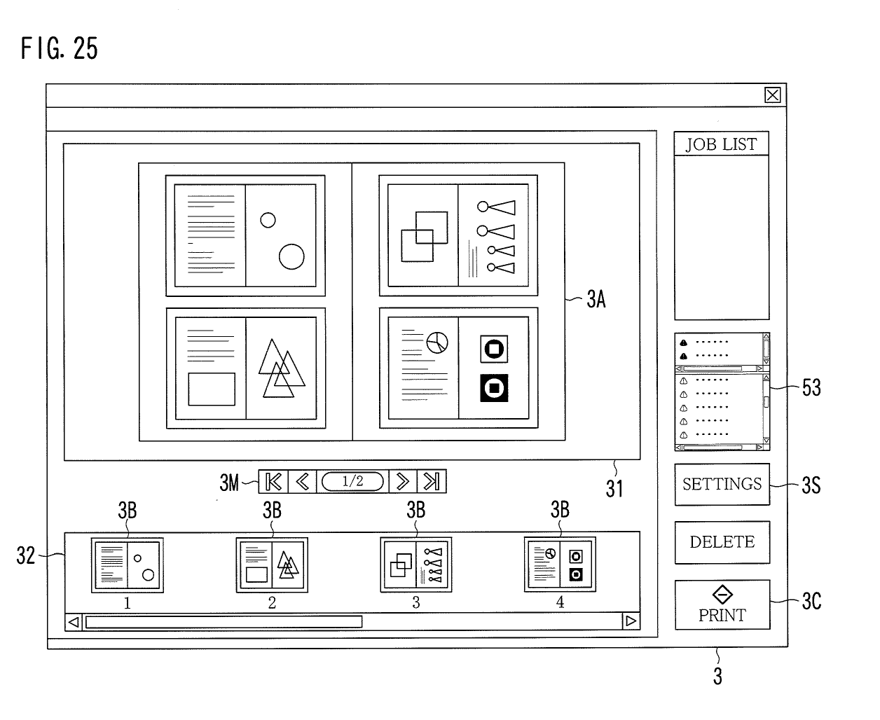

Responsive to these settings, the personal computer 2 displays a preview image 3A and thumbnail images 3B as shown in FIG. 25. Since the 2-in-1 printing is set in the application 2AP, images of not one page but two pages of the original pages of the document 6 are shown as one thumbnail image 3B. Due to the same reason, images of not two pages but four pages of the original pages of the document 6 are displayed in each of the right half and the left half of one preview image 3A, irrespective of settings of 2-in-1 printing and booklet printing made by the user for the printer driver 2DR2.

The user can notice a setting error by viewing the preview image 3A and the thumbnail images 3B. In addition, the user can identify easily whether 4-in-1 printing rather than 2-in-1 printing is erroneously set for the printer driver 2DR2, or, alternatively, 2-in-1 printing is erroneously set for the application 2AP. For the former case, the preview image 3A and the thumbnail images 3B are displayed as shown in FIG. 24. For the latter case, the preview image 3A and the thumbnail images 3B are displayed as shown in FIG. 25.

Subsequently, the user makes settings again for the application 2AP or the printer driver 2DR2, so that a desired printed matter can be obtained.

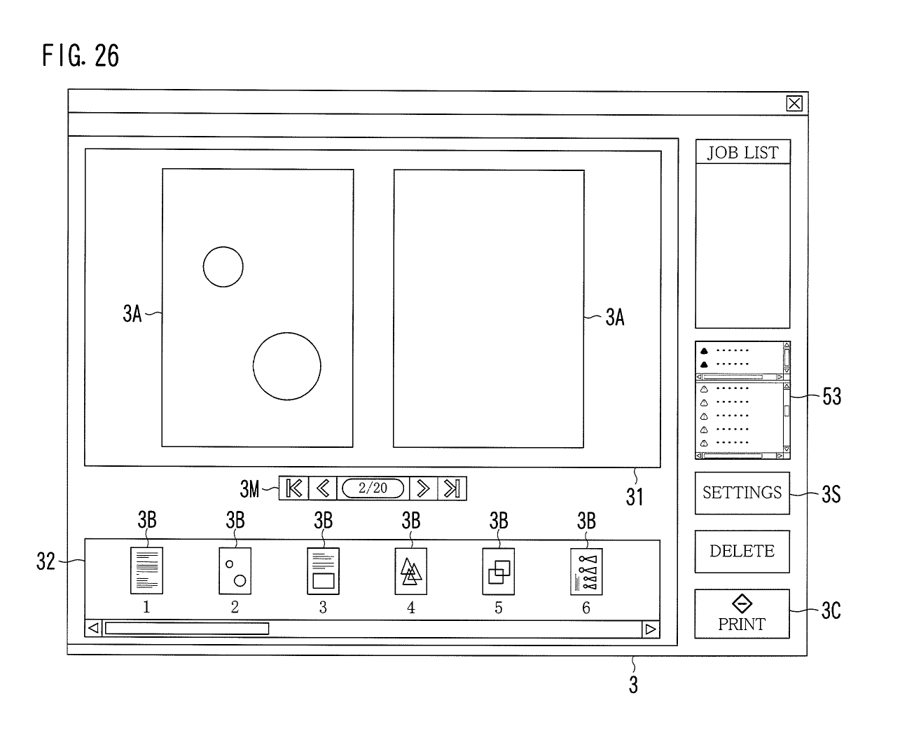

Suppose that, for example, the number of pages of the document 6 is 5, and settings are erroneously made in which a blank (white) page is inserted between Page 2 and Page 3. In such a case, the personal computer 2 displays preview images 3A and thumbnail images 3B as shown in FIG. 26.

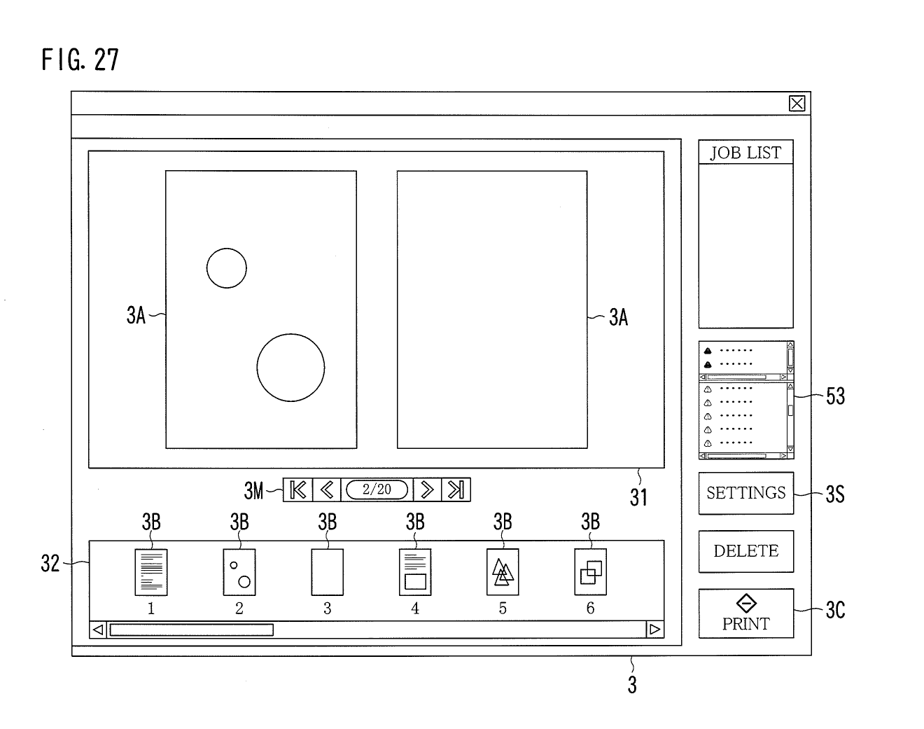

There is a case in which a user prepares a document 6 having five pages, and thereafter, a blank page is erroneously inserted between Page 2 and Page 3, and further, a print command is entered without correcting this error. In such a case, the personal computer 2 displays preview images 3A and thumbnail images 3B as shown in FIG. 27.

The user can notice the presence of a page that is added without his/her intent by viewing the preview images 3A as shown in FIG. 26 or 27.

Further, a cause of the error can be easily identified by referring to the thumbnail image 3B in the following manner. In the case where no thumbnail images 3B show a blank page as shown in FIG. 26, the user can notice that there is an error in settings made for the printer driver 2DR2. On the other hand, as shown in FIG. 27, when a third thumbnail image 3B of Page 3 shows a blank page, the user can notice that operation for inserting a blank page has erroneously been performed for the application 2AP.

The second embodiment enables a user to find out an output defect of a document more easily than is conventionally possible.

The following image forming apparatus has been proposed as an image forming apparatus using a preview-related technique. The image forming apparatus is provided with a photographing part for photographing the original placed on an original holder; a printed image generation part for generating a printed image obtained by applying a printing condition set by a user to a photographic image taken by the photographing part; and a display part for displaying the photographic image and the printed image (Japanese Laid-open Patent Publication No. 2008-107651).

In this way, conventional techniques involve simulating the appearance of a printed matter on which an image is printed and previewing the appearance thereof.

However, such a preview is sometimes not enough to identify a cause of an output defect of a document.

The second embodiment solves such a problem and enables a user to easily find out an output defect of a document more easily than is conventionally possible.

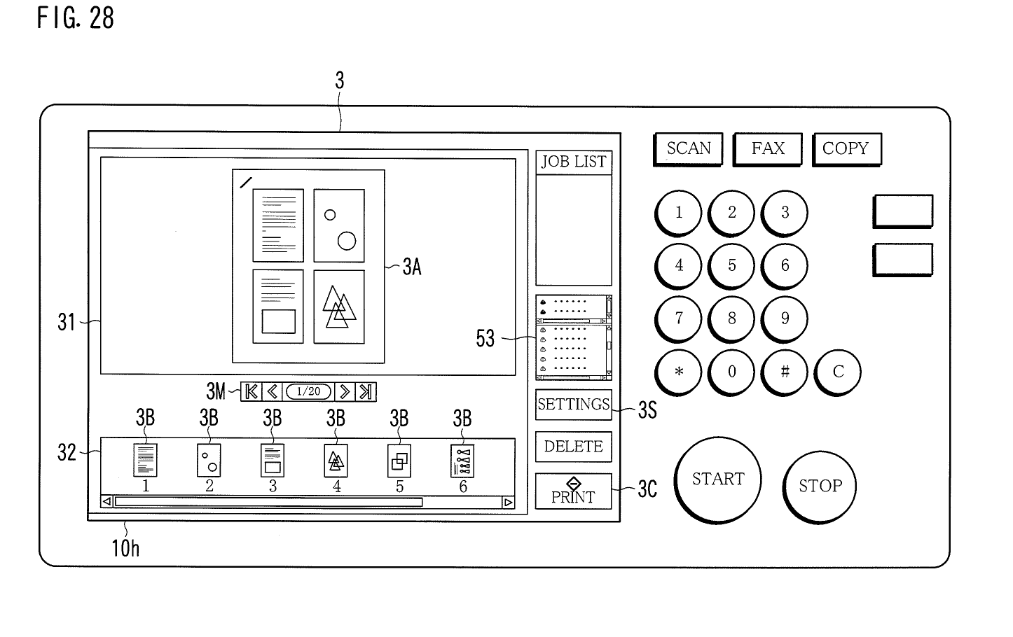

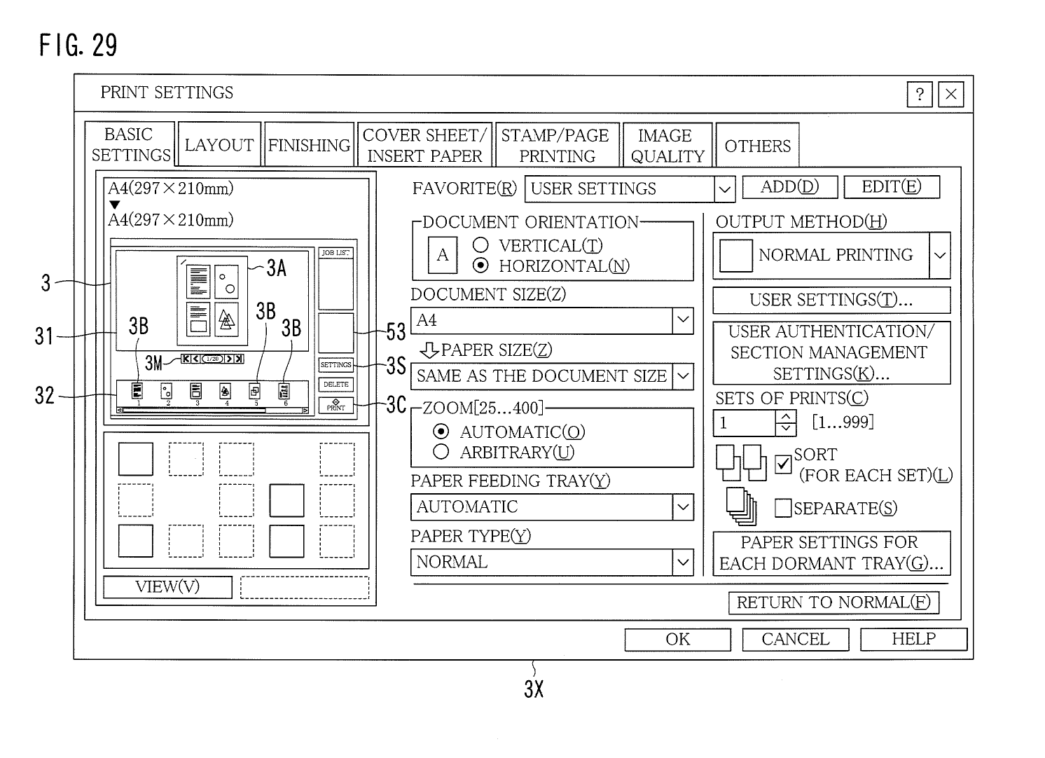

FIG. 28 is a diagram showing an example of a print preview window 3 displayed on the touch-sensitive panel display 10h, and FIG. 29 is a diagram showing an example of a driver screen 3× having a region corresponding to the print preview window 3.

In the second embodiment, it is a personal computer 2 that displays the print preview window 3, i.e., performs a preview display. Instead of this, however, the image forming apparatus 1 may perform such a display. In such a case, the image forming apparatus 1 may be provided with modules for implementing the functions of the individual portions shown in FIG. 18. Then, the print preview window 3 may be displayed in the touch-sensitive panel display 10h as shown in FIG. 28.

Alternatively, the personal computer 2 may be provided with the document data entry portion 251 through the processed image generating portion 254, and the image forming apparatus 1 may be provided with functions corresponding to the image storage portion 255 and the print preview display portion 256. Stated differently, the personal computer 2 may generate data of a preview image 3A and data of a thumbnail image 3B, and transfer the data generated to the image forming apparatus 1, and the image forming apparatus 1 may display the preview image 3A and the thumbnail image 3B.

Further, when a user selects any one of thumbnail images 3B by clinking the same or other operation, and when a preview image 3A corresponding to a page of the selected thumbnail image 3B is not displayed in the preview image region 31, the preview image display portion 263 may display the preview image 3A. In short, the thumbnail image 3B may be used as an icon to invoke the preview image 3A.

Likewise, when a user selects any one of preview images 3A by clicking the same or other operation, and when a thumbnail image 3B corresponding to a page of the selected preview image 3A is not displayed in the thumbnail image region 32, the thumbnail image display portion 264 may display the thumbnail image 3B.

In the second embodiment, the case is discussed in which a document 6 is outputted as a printed matter. Other than this, the present invention is also applicable to a case of generating an electronic file of a document in the form of so-called layout document such as Portable Document Format (PDF) or XML Paper Specification (XPS).

As shown in FIG. 29, the print preview window 3 may be incorporated into a driver screen 3× that is a driver screen of the image forming apparatus 1.

In the embodiments discussed above, the entire or partial configuration of the image forming apparatus 1 and the personal computer 2, the processing details, the processing order, the data structure, the structure of the print preview window 3 or 5, and the like may be altered as required in accordance with the subject matter of the present invention. Further, the content to be processed, the processing sequence, and the like of the image processing apparatus 1 may be altered as required in accordance with the subject matter of the present invention.

While example embodiments of the present invention have been shown and described, it will be understood that the present invention is not limited thereto, and that various changes and modifications may be made by those skilled in the art without departing from the scope of the invention as set forth in the appended claims and their equivalents.

What is claimed is:

1. A document information display control device for displaying, on a display, information on a document having a plurality of pages, the device comprising:
a detector configured to detect an entire state and an individual state that are probably found in a first case where a printer obtains a printed matter of the document by printing the document, or, in a second case where a finisher applies finishing processing to the printed matter, the entire state being a state on an entirety of the printed matter, the individual state being a state on each of the plurality of the pages; and
a state information display control portion configured to display a screen including entire state information and individual state information, the entire state information indicating the entire state detected by the detector, and the individual state information indicating the individual state detected by the detector.

2. The document information display control device according to claim 1, further comprising a thumbnail image display control portion configured to display a thumbnail image of each of the plurality of pages in the screen.

3. The document information display control device according to claim 1, wherein the state information display control portion displays, as a list, the entire state information and the individual state information.

4. The document information display control device according to claim 3, wherein the state information display control portion displays the entire state information so as to be provided above the individual state information.

5. The document information display control device according to claim 3, wherein the state information display control portion displays the individual state information in order from the individual state information having a smallest page number to the individual state information having a largest page number thereof.

6. The document information display control device according to claim 1, further comprising
a preview image display control portion configured to display a preview image in the screen, the preview image showing appearance of a print surface of any of the plurality of pages,
a thumbnail image display control portion configured to display a thumbnail image of each of the plurality of pages in the screen, the thumbnail image having a size smaller than a size of the preview image, and
a cursor display control portion configured to display a cursor on the display in such a manner that the cursor is placed on any one of the thumbnail images;
wherein
when any one piece of the entire state information and the individual state information is selected, the cursor display control portion displays the cursor in such a manner that the cursor is placed on the thumbnail image of a page, of the plurality of pages, corresponding to the entire state information selected or the individual state information selected, and
the preview image display control portion displays the preview image of the page.

7. The document information display control device according to claim 1, further comprising
a thumbnail image display control portion configured to display a thumbnail image of each of the plurality of pages in the screen, and
a cursor display control portion configured to display a cursor on the display in such a manner that the cursor is placed on any one of the thumbnail images in accordance with operation by a user;
wherein the state information display control portion first displays the individual state information of a page, of the plurality of pages, corresponding to the thumbnail image designated by the cursor in accordance with movement of the cursor.

8. The document information display control device according to claim 1, wherein the state information display control portion does not display the individual state information for a page selected from among the plurality of pages by a user, and, instead, displays the individual state information for a page not selected from among the plurality of pages by the user.

9. The document information display control device according to claim 1, wherein the detector detects, as the entire state, at least one of the following: a first state where staple finishing is not applicable to the printed matter; a second state where hole-punch finishing is not applicable to the printed matter; and a third case where fold finishing is not applicable to the printed matter.

10. The document information display control device according to claim 1, wherein the detector detects, as the individual state of each page of the plurality of pages, at least one of the following: a fourth state where a ratio of an area excluding an object contained in said each page to an area of paper to be used for printing an image on said each page is a predetermined ratio or more; a fifth state where the image on said each page extends off the paper; a sixth state where a size of a letter contained in said each page is larger than a first size; and a seventh state where the size of the letter contained in said each page is smaller than a second size.

11. The document information display control device according to claim 1, further comprising a detailed information display control portion configured to display, when any one piece of the entire state information and the individual state information is selected, detailed information on a cause or a solution to the entire state information selected or the individual state information selected on the display.

12. The document information display control device according to claim 1, further comprising
a preview image display control portion configured to display, on the display, a preview image showing appearance of the document for a case where specific processing is performed on the document, and
an original image display control portion configured to display on the display, together with the preview image, an original image showing appearance of each of the plurality of pages that is not subjected to the specific processing.

13. The document information display control device according to claim 12, wherein the specific processing is to process the document in order that the printer prints an image on the document onto paper.

14. The document information display control device according to claim 12, wherein the specific processing is to lay out, on paper, each of the plurality of pages.

15. The document information display control device according to claim 12, further comprising a specific processing portion configure to perform the specific processing on the document;
wherein the preview image display control portion displays, as the preview image, an image of appearance of the document for a case where the specific processing portion performs the specific processing on the document.

16. The document information display control device according to claim 12, wherein the original image is smaller than the preview image.

17. The document information display control device according to claim 12, wherein the preview image shows appearance of the printed matter for a case where finishing processing is performed on the document.

18. The document information display control device according to claim 12, wherein the preview image display control portion displays the preview image of a page, of the plurality of pages, corresponding to the original image selected.

19. The document information display control device according to claim 12, wherein the original image display control portion displays the original image of a page, of the plurality of pages, corresponding to the preview image selected.

20. A document information display control method used in a computer for displaying, on a display, information on a document having a plurality of pages to implement, the method comprising:
causing the computer to detect an entire state and an individual state that are probably found in a first case where a printer obtains a printed matter of the document by printing the document, or, in a second case where a finisher applies finishing processing to the printed matter, the entire state being a state on an entirety of the printed matter, the individual state being a state on each of the plurality of the pages; and
causing the computer to display a screen including entire state information and individual state information, the entire state information indicating the entire state detected, and the individual state information indicating the individual state detected.

21. A non-transitory computer-readable storage medium storing thereon a computer program used in a computer for displaying, on a display, information on a document having a plurality of pages to implement, the computer program causing the computer to implement processes comprising:
causing the computer to detect an entire state and an individual state that are probably found in a first case where a printer obtains a printed matter of the document by printing the document, or, in a second case where a finisher applies finishing processing to the printed matter, the entire state being a state on an entirety of the printed matter, the individual state being a state on each of the plurality of the pages; and
causing the computer to display a screen including entire state information and individual state information, the entire state information indicating the entire state detected, and the individual state information indicating the individual state detected.
